(19) United States
(12) Patent Application Publication
(10) Pub. No.: US 2025/0109257 A1
(43) Pub. Date: Apr. 3, 2025

(54) GRAFT COPOLYMERS FOR REDUCING THE SURFACE TENSION IN POLYMER BLENDS

(71) Applicant: Covestro Deutschland AG, Leverkusen (DE)

(72) Inventors: Andreas Seidel, Dormagen (DE); Mandy Gieler, Dernau (DE); Marina Reithmeier, Köln (DE); Jose Gamez, Köln (DE); Jan Meyer, Wuppertal (DE); Tianhang Zhou, Darmstadt (DE); Florian Müller-Plathe, Frankfurt am Main (DE)

(21) Appl. No.: 18/848,188

(22) PCT Filed: Mar. 29, 2023
(86) PCT No.: PCT/EP2023/058085

§ 371 Date: Sep. 18, 2024

(30) Foreign Application Priority Data
Apr. 4, 2022 (EP) 22166509.4

(51) Int. Cl. C08G 81/02; C08L 23/12; C08L 25/06; C08L 69/00

(52) U.S. Cl. CPC C08G 81/027; C08L 23/12; C08L 25/06; C08L 69/00; C08L 2205/03; C08L 2205/08

(57) ABSTRACT

The invention relates to a graft copolymer of the general structure B-(A)ₙₘ, consisting of blocks of the two polymers A and B, which have different chemical compositions. One of the polymers is a polycondensation polymer, selected from the group consisting of polycarbonates, polyester carbonates, polyesters, and polyamides, and the other polymer is a polymerisate of at least one vinyl monomer. The invention is characterized in that (i) the average molecular weight of the block of polymer B Mₙ(B) equals at least 13 kg/mol, determined by a combination of gel permeation chromatography and NMR spectroscopy, (ii) the number of side chains in the graft copolymer nₛ equals at least 3 and maximally 15, determined by NMR spectroscopy, (iii) the average molecular weight of the block of polymer A Mₙ(A) equals at least 1.5 kg/mol and maximally 15 kg/mol, determined by a combination of gel permeation chromatography and NMR spectroscopy, and (iv) nₛ multipled by Mₙ(A) equals at least 13 kg/mol. The invention also relates to the use of the aforementioned graft copolymers in order to reduce the phase surface tension in mixtures containing the polymers A and B, to compositions containing the graft copolymers and the polymers A and B, and to molded bodies containing said compositions.

The present invention relates to graft copolymers of a specific architecture consisting of blocks of two polymers A and B of differing chemical composition, wherein one of the polymers is a polycondensation polymer selected from the group consisting of polycarbonates, polyestercarbonates, polyesters, and polyamides and the other polymer is a polymer of one or more different vinyl monomers. The invention further relates to the use of these graft copolymers for reducing the interfacial tension between phases in mixtures comprising homopolymers A and B or in mixtures of polymers having comparable polarity, to compositions comprising the graft copolymers as well as homopolymers A and B or polymers of comparable polarity, to molding compounds produced from such compositions, and to molded articles produced from these molding compounds.

Mixtures of immiscible polymers of differing chemical composition are suitable for producing multiphase polymer blends having properties that sometimes combine the specific use advantages of the two polymers in a synergistic manner. However, if the differences in polarity of polymers A and B are too great, i.e. the interfacial tension at the phase interface of the two polymers is too great, the polymer blends tend to undergo phase separation. A resulting coarse and/or unstable phase morphology or poor phase adhesion then often leads to undesirable effects such as poor light transmission, phase delamination, poor processing stability, inadequate mechanical properties (for example material ductility/toughness, elongation at break, resistance to stress cracking or weld line strength), cosmetic surface defects on injection-molded components formed from the polymer blend via a thermoplastic processing process, especially in the event of high shear, or removal of decorative layers applied on injection-molded components. In order to achieve desired technical property profiles in such cases, it is often necessary to add to the polymer blend compositions a compatibilizer that reduces the interfacial tension between the polymers forming the blend, thereby reducing the aforementioned technical problems or ideally eliminating them altogether.

Mixtures of polymers of differing chemical composition are also suitable for the production of block copolymers consisting of blocks of chemically different polymer species through the reaction of two polymers with one another in the multiphase melt of the polymer mixture. Since such a reaction is by definition able to occur only at the phase interface of the different polymers in the melt, the rate of reaction of such melt reactions depends on the size of the phase interface, i.e. of the phase dispersion, or the domain size of the different polymers in the melt mixture. Thermodynamically stable, finely divided phase morphologies in the melt are accordingly required in order to achieve high levels of conversion within technically possible or reasonable reaction residence times and often necessitate a reduction in the interfacial tension between the different polymers in the melt mixture, i.e. the use of compatibilizers as process auxiliaries.

As compatibilizers in a polymer mixture composed of two chemically different polymers A and B, past experience has demonstrated the suitability of block copolymers consisting of blocks of polymers A and B, a common perception based on experience with the emulsification of immiscible low-viscosity liquids being that bipolar A-B block copolymer architectures generally appear particularly attractive to those skilled in the art with regard to achieving a high degree of effectiveness for the intended purpose. Such block copolymer structures are however difficult to synthesize in the case of block copolymers comprising a polycondensation polymer as block A and a vinyl (co)polymer as block B. A generally more readily obtainable synthetic option is graft copolymers consisting of blocks of a polycondensation polymer and of a vinyl (co)polymer.

For example, U.S. Pat. No. 4,959,411 discloses a process for producing a copolymer through the reaction in organic solution or in a melt compounding of a glycidyl methacrylate-grafted olefin polymer with a carboxy-functionalized polycarbonate and the use of such a copolymer, which is clearly a graft copolymer, for the compatibilization of polycarbonate-polyolefin polymer blends with the aim of reducing their tendency to delamination. This application is completely silent about an effect of the spatial arrangement of the graft branches on the graft backbone/number of graft branches or of the length of the graft branches and of the graft backbone on the effectiveness of the graft copolymers as compatibilizers in polymer blends.

The graft copolymers of the prior art are insufficiently effective in reducing the interfacial tension between phases in blends or melt mixtures of the polymers A and B from which they are formed.

US 2006/063891 A1 discloses graft copolymers having a B-(A) architecture that are composed of free-radical-produced polymers as blocks A and B and consisting of preferably n=2-8 graft branches of polymer A having an average molecular weight Mₙ(A) of preferably 20 000 to 100 000 g/mol grafted on the backbone of polymer B having an average molecular weight Mₙ(B) of preferably >50 000 g/mol and wherein the relative block lengths are selected such that n·Mₙ(A)/(n·Mₙ(A)+Mₙ(B)) is preferably within the range from 0.6 to 0.8. The application discloses that these graft copolymers are suitable for impact modification of transparent polymers. This application is silent about their effect as compatibilizers in blends of homopolymers A and B.

CN 108586668 A discloses a polypropylene/polylactic acid ion-grafted copolymer having high toughness and a production process therefor. The process provided by the invention is simple and low-cost and uses the interaction of anions and cations to graft the polylactic acid onto the main chain. Nothing is disclosed about an effect as a compatibilizer.

US2012/071606 A1 discloses a process for forming polycarbonate graft copolymers. More particularly, a polycarbonate polymer or copolymer containing allyl groups constitutes the backbone for the graft copolymer and the side chains are attached to the copolymer via the allyl groups. The graft copolymers show a combination of high transparency, good levels of grafting, good scratch resistance and/or good anti-fog properties. This disclosure too provides no indication of an influence on phase compatibility.

US 488401 A discloses a resin composition for optics comprising primarily a graft copolymer that comprises a styrene resin and an aromatic polycarbonate, each having a specific molecular weight at a specific ratio of molecular weight and weight, wherein the composition has a microdisperse phase of not more than 0.5 μm. The resin composition is suitable for optics use. Nothing is disclosed about phase compatibilization.

JP H09 143293 A discloses a film having a layer composed of a graft copolymer of a polyester with an acrylic polymer. The layer ensures good lubricity and printability. Nothing is disclosed about the effect of the graft copolymer as a phase compatibilizer.

The basis for the present invention was the desire to provide special graft copolymers that, as additives or process auxiliaries under comparable conditions, i.e. using the same concentration of substances, exhibit an improved effect in reducing the interfacial tension in polymer blends and/or reactive melt mixtures composed of polymers A and B of differing chemical composition, where one of the polymers is a polycondensation polymer selected from the group consisting of polycarbonates, polyestercarbonates, polyesters, polyamides, and mixtures thereof and the other polymer is a polymer composed of one or more different vinyl monomers. The vinyl monomers are preferably selected from the group consisting of styrene, styrene derivatives, vinyl cyanides, acrylic esters, acrylic ester derivatives, olefins, maleimide, and maleimide derivatives. The aim is ultimately that these graft copolymers are thereby able to contribute to an improved solution for at least one of the abovementioned technical problems that arise from the poor compatibility of polymers A and B.

In the context of the present invention, the variable E=(1−γ/γ₀) serves as a measure of the reduction in interfacial tension and is referred to as the phase compatibilizer efficiency. γ₀ is here the interfacial tension of the uncompatibilized polymer blend composed of homopolymers A and B, i.e. the interfacial tension at the phase interface of such polymers in the absence of the graft copolymers, and γ is the value for the interfacial tension reduced by the addition of the graft copolymers. If the graft copolymer shows no effect at all as a compatibilizer, then γ=γ₀ and thus E=0. In the other extreme case of best-possible phase compatibilization, the interfacial tension at the phase interface of the homopolymers A and B is reduced to the value γ=0 in the presence of the graft copolymers, i.e. complete miscibility is achieved. Thus, in this case, E=1. The value for the phase compatibilizer efficiency E is by definition dependent on the use concentration of the graft copolymer. In the context of the present invention, under the conditions employed in the experiments that served as the basis therefor, a minimum value of 30, preferably a minimum value of 35, further preferably of 40, more preferably of 45, was considered desirable. It was also desirable for these graft copolymers to display their effective effect at the lowest possible molecular weight of the employed graft copolymer, since graft copolymers having an excessively high molecular weight have lower diffusion coefficients in polymer melts and consequently, for kinetic reasons, is able to migrate less readily (i.e. more slowly) in polymer blends to the interface of the polymer components in order to be able to effectively display their desired effect there.

The object is achieved by graft copolymers of the general structure B-(A)ₘ. consisting of blocks of two polymers A and B of differing chemical composition, wherein one of the polymers, preferably polymer A, is a polycondensation polymer selected from the group consisting of polycarbonates, polyestercarbonates, polyesters, and polyamides and the other polymer, preferably polymer B, is a polymer composed of at least one vinyl monomer, characterized in that
(i) the number-average molecular weight of the block of polymer B Mₙ(B) is at least 13 kg/mol, determined by a combination of gel-permeation chromatography and NMR spectroscopy,
(ii) the number of side chains in the graft copolymer nₛ, determined by NMR spectroscopy, is at least 3 and not more than 15,
(iii) the number-average molecular weight of the blocks of polymer A Mₙ(A) is at least 1.5 kg/mol and not more than 15 kg/mol, determined by a combination of gel-permeation chromatography and NMR spectroscopy, and
(iv) nₛ multiplied by Mₙ(A) comes to at least 13 kg/mol.

In the case of a mixture of graft copolymer molecules having different individual nₛ values, the characteristic “nₛ” as stated in the preferred ranges, embodiments, and claims mentioned in the present invention generally refers to the number-average arithmetic mean of the nₛ values of the individual polymer molecules.

The value for nₛ is preferably at least 4, more preferably at least 5, and most preferably at least 6. Mₙ(A) is preferably at least 3.0 kg/mol, more preferably at least 4.5 kg/mol, and most preferably at least 5.3 kg/mol.

Mₙ(B) is preferably at least 20 kg/mol, more preferably at least 23 kg/mol, and most preferably at least 30 kg/mol.

The value for nₛ×Mₙ(A) is preferably at least 20 kg/mol, more preferably at least 30 kg/mol, and most preferably at least 35 kg/mol.

The value for nₛ is preferably not more than 12, further preferably not more than 10, more preferably not more than 8.

The value for Mₙ(B) is preferably not more than 200 kg/mol, further preferably not more than 100 kg/mol, more preferably not more than 50 kg/mol.

The value for Mₙ(A) is preferably not more than 12 kg/mol, preferably not more than 9 kg/mol, more preferably not more than 8 kg/mol.

The value for nₛ multiplied by Mₙ(A) is preferably not more than 120 kg/mol, further preferably 80 kg/mol, more preferably 50 kg/mol.

It is preferable that Mₙ(A)×nₛ/[Mₙ(B)+Mₙ(A)×nₛ] is in the range from 0.25 to 0.75, further preferably in the range from 0.40 to 0.70, and more preferably in the range from 0.40 to 0.60.

All combinations of the upper and lower limits of nₛ, Mₙ(A), Mₙ(B), and nₛ×Mₙ(A) and of the ranges for Mₙ(A)×nₛ/[Mₙ(B)+Mₙ(A)×nₛ] are possible.

Preference is given especially to graft copolymers characterized by the combination of the following characteristics:
(i) Mₙ(B) of at least 23 kg/mol,
(ii) nₛ of at least 5,
(iii) Mₙ(A) of at least 3.0 kg/mol, and
(iv) nₛ multiplied by Mₙ(A) of at least 13 kg/mol.

Particularly preferred graft copolymers are characterized by the combination of the following characteristics:
(i) Mₙ(B) of at least 23 kg/mol,
(ii) nₛ of at least 6,
(iii) Mₙ(A) of at least 4.5 kg/mol, and
(iv) nₛ multiplied by Mₙ(A) of at least 13 kg/mol.

Most preferred graft copolymers are characterized by the combination of the following characteristics:
(i) Mₙ(B) of at least 23 kg/mol,
(ii) nₛ of at least 6,
(iii) Mₙ(A) of at least 4.5 kg/mol,
(iv) nₛ multiplied by Mₙ(A) of at least 13 kg/mol, and
(v) Mₙ(A)×nₛ/[Mₙ(B)+Mₙ(A)×nₛ] in the range from 0.40 to 0.70.

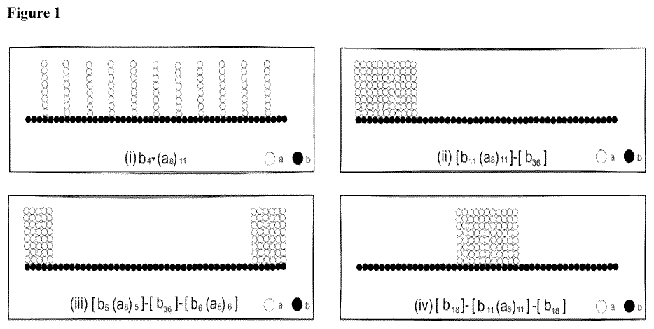

The graft copolymers of the invention may additionally differ in respect of their architecture, i.e. the spatial distribution of the graft branches on the graft copolymer backbone. The grafting of the graft branches on the graft copolymer backbone may show a random distribution here (“randomly grafted”). It is likewise possible that (i) the graft branches are arranged uniformly and equidistantly on the graft copolymer backbone (“uniformly equidistantly grafted”). It is additionally possible that (ii) the graft branches are arranged entirely at one end of the graft copolymer backbone (“singly terminally grafted”), (iii) the graft branches are arranged at either end of the graft copolymer backbone (“doubly terminally grafted”), or (iv) the graft branches are arranged at the center of the graft copolymer backbone of the graft copolymer (“centrally grafted”). Architectures (i) to (iv) are depicted schematically in FIG. 1.

The graft copolymer of the invention is preferably centrally grafted or doubly terminally grafted and is more preferably centrally grafted.

Architectures (ii), (iii), and (iv) have a graft copolymer backbone that comprises sections with graft branches and sections without graft branches. Preference is given here to graft copolymers in which the sections of the graft copolymer backbone with graft branches together comprise a mass fraction of not more than 50% by weight, further preferably not more than 40% by weight, more preferably not more than 30% by weight, of the graft copolymer backbone.

The polymer composed of the vinyl monomers is in the context of the present invention also referred to as vinyl (co)polymer.

Block B is in the context of the present invention also referred to as graft copolymer backbone, graft copolymer backbone or backbone. Blocks A are referred to as side chains or graft branches.

The at least one vinyl monomer is preferably selected from the group consisting of styrene, styrene derivatives, vinyl cyanides, acrylic esters, acrylic ester derivatives, olefins, maleimide and maleimide derivatives.

The blocks of polymers A and B preferably have polarities and further preferably chemical structures similar to those of the polymers that form the polymer blend or polymer melt mixture for which a reduction in interfacial tension is sought. That is to say, the polymer combination of blocks A and B preferably has a Flory-Huggins parameter similar to that of the combination of polymers that form the polymer blend or polymer melt mixture for which a reduction in interfacial tension is sought.

It is further preferable that the blocks consist of the same polymers A and B that are also present in the polymer blend or polymer melt mixture for which a reduction in interfacial tension is sought. The phrase “of the same polymers A and B” refers to the chemical structure, but not necessarily to the molecular weight.

### Polycondensation Polymer

One of the polymers from which the graft copolymer of the invention is formed, preferably polymer A, is a polycondensation polymer selected from the group consisting of polycarbonates, polyestercarbonates, polyesters, and polyamides. Mixtures of different polycondensation polymers having similar polarity and chemical structure may also be used, for example mixtures of structurally different, preferably aromatic, polycarbonates, preferably aromatic polyestercarbonates or preferably aromatic polyesters, preferably mixtures of structurally different, preferably aromatic, polycarbonates or mixtures of structurally different, preferably aromatic, polyestercarbonates or mixtures of structurally different, preferably aromatic, polyesters, more preferably mixtures of structurally different, preferably aromatic, polycarbonates.

Polycarbonates and/or polyestercarbonates corresponding to component A that are suitable according to the invention are known from the literature or can be produced by processes known from the literature (for the production of polycarbonates see for example Schnell, “Chemistry and Physics of Polycarbonates”, Interscience Publishers, 1964 and DE-AS 1495 626, DE-A 2 232 877, DE-A 2 703 376, DE-A 2 714 544, DE-A 3 000 610, DE-A 3 832 396; for the production of polyestercarbonates, for example DE-A 3 007 934).

The polycarbonates are produced for example by reacting at least one aliphatic and/or aromatic diol (diphenol) with carbonyl halides, preferably phosgene, and/or with preferably aromatic dicarbonyl dihalides, preferably benzenedicarbonyl dihalides, by the interfacial process, optionally using chain terminators, for example monophenols, and optionally using trifunctional or more than trifunctional branching agents, for example triphenols or tetraphenols. Mixtures of aliphatic and aromatic diols may also be used. Production via a melt polymerization process through reaction of aliphatic and/or aromatic diols (diphenols) with, for example, diphenyl carbonate is likewise possible.

Diphenols for the production of the aromatic polycarbonates and/or aromatic polyestercarbonates are preferably those of the formula (1)

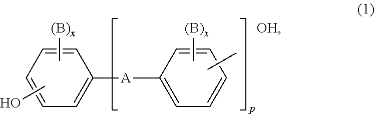

where
A is a single bond, C₁ to C₅ alkylene, C₂ to C₅ alkylidene, C₅ to C₆ cycloalkylidene, —O—, —SO—, —CO—, —S—, —SO₂—, C₆ to C₁₂ arylene, onto which further aromatic rings optionally containing heteroatoms may be fused,
   or a radical of the formula (2) or (3)

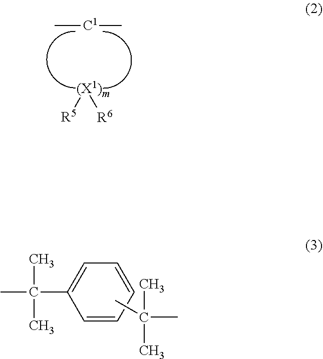

B is in each case C, to C₁₂ alkyl, preferably methyl, halogen, preferably chlorine and/or bromine,
x is in each case independently 0, 1 or 2,
p is 1 or 0, and
R⁵ and R⁶ may be selected individually for each X¹ and are each independently hydrogen or C₁ to C₆ alkyl, preferably hydrogen, methyl or ethyl,
X¹ is carbon and
m is an integer from 4 to 7, preferably 4 or 5, with the proviso that, on at least one atom X¹, R⁵, and R⁶ are both alkyl.

Preferred diphenols are hydroquinone, resorcinol, dihydroxydiphenols, bis(hydroxyphenyl) C₁-C₅ alkanes, bis(hydroxyphenyl) C₅-C₆ cycloalkanes, bis(hydroxyphenyl) ethers, bis(hydroxyphenyl) sulfoxides, bis(hydroxyphenyl) ketones, bis(hydroxyphenyl) sulfones, and α,α-bis(hydroxy-phenyl)diisopropyl-benzenes and also ring-brominated and/or ring-chlorinated derivatives thereof.

Particularly preferred diphenols are 4,4′-dihydroxydiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclo-hexane, 4,4′-dihydroxydiphenyl sulfide, 4,4′-dihydroxydiphenyl sulfone, and the di- and tetrabrominated or chlorinated derivatives thereof, for example 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. Particular preference is given to 2,2-bis(4-hydroxyphenyl)propane (bisphenol A).

The diphenols may be used individually or in the form of any desired mixtures. The diphenols are known from the literature or obtainable by literature processes.

Suitable aliphatic diols are selected from the group consisting of cyclohexane-1,2-diol, cyclohexane-1,3-diol, cyclohexane-1,4-diol, cyclohexane-1,2-dimethanol, cyclohexane-1,3-dimethanol, cyclohexane-1,4-dimethanol, 2,2-bis(4-hydroxycyclohexyl)propane, tetrahydrofuran-2,5-dimethanol, 2-butyl-2-ethylpropane-1,3-diol, 2-(2-hydroxyethoxy)ethanol, 2,2,4,4-tetramethylcyclobutane-1,3-diol, 2,2,4-trimethylpentane-1,3-diol, 2,2-dimethylpropane-1,3-diol, cyclobutane-1,1-diyldimethanol, 8-(hydroxymethyl)-3-tricyclo[5.2.1.02,6]decanyl]methanol, propane-1,2-diol, propane-1,3-diol, butane-1,4-diol, pentane-1,5-diol, hexane-1,6-diol, octane-1,8-diol, isosorbide and any desired mixtures thereof.

Examples of chain terminators suitable for the production of the thermoplastic aromatic polycarbonates include phenol, p-chlorophenol, p-tert-butylphenol or 2,4,6-tribromophenol, but also long-chain alkyl phenols, such as 4[2-(2,4,4-trimethylpentyl)]phenol, 4-(1,3-tetramethylbutyl)phenol in accordance with DE-A 2 842 005 or monoalkyl phenol or dialkyl phenols having a total of 8 to 20 carbon atoms in the alkyl substituents, such as 3,5-di-tert-butylphenol, p-isooctylphenol, p-tert-octylphenol, p-dodecylphenol, and 2-(3,5-dimethylheptyl)phenol and 4-(3,5-dimethylheptyl)phenol. The amount of chain terminators to be used is generally between 0.5 mol % and 10 mol % based on the molar sum of the diphenols used in each case.

The thermoplastic aromatic polycarbonates may be branched in a known manner through incorporation of trifunctional or more than trifunctional compounds, for example ones having three or more phenolic groups. Preference is however given to using linear polycarbonates, further preferably ones based on bisphenol A.

Both homopolycarbonates and copolycarbonates are suitable. The copolycarbonates of the invention corresponding to component A may also be produced using 1% to 25% by weight, preferably 2.5% to 25% by weight, based on the total amount of diols to be used, of polydiorganosiloxanes having hydroxyaryloxy end groups. These are known (U.S. Pat. No. 3,419,634) and can be produced by known literature processes. The production of polydiorganosiloxane-containing copolycarbonates is described for example in DE-A 3 334 782 and WO 2015/052106 A2.

Preference is also given to copolycarbonates produced using diphenols of the following structures:

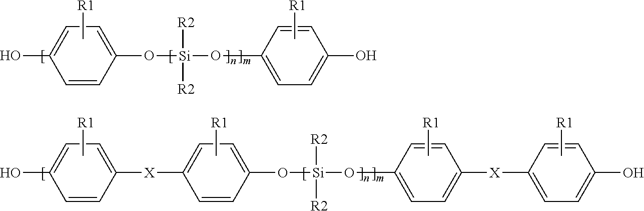

where R1 is hydrogen, C₁ to C₄ alkyl, preferably hydrogen or methyl, and especially preferably hydrogen,
R2 is independently aryl or alkyl, preferably methyl,
X is a single bond, —SO₂—, —CO—, —O—, —S—, C, to C₆ alkylene, C₂ to C₅ alkylidene or C₆ to C₁₂ arylene, which may optionally be fused with further aromatic rings containing heteroatoms,
X is preferably a single bond, C₁ to C₅ alkylene, C₂ to C₅ alkylidene, C₅ to C₁₂ cycloalkylidene, —O—, —SO—, —CO—, —S—, —SO₂—, particularly preferably X is a single bond, isopropylidene, C₅ to C₁₂ cycloalkylidene or oxygen, and very particularly preferably is isopropylidene,
n is an average number from 10 to 400, preferably 10 to 100, especially preferably 15 to 50, and
m is an average number from 1 to 10, preferably from 1 to 6 and especially preferably from 1.5 to 5.

Aromatic dicarbonyl dihalides for the production of aromatic polyestercarbonates are preferably the diacyl dichlorides of isophthalic acid, of terephthalic acid, of diphenyl ether 4,4′-dicarboxylic acid, and of naphthalene-2,6-dicarboxylic acid. Particular preference is given to mixtures of the diacyl dichlorides of isophthalic acid and terephthalic acid in a ratio of between 1:20 and 20:1.

For the production of polyestercarbonates, a carbonyl halide, preferably phosgene, is also additionally used as bifunctional acid derivative.

Useful chain terminators for the production of the aromatic polyestercarbonates include, aside from the monophenols already mentioned, the chlorocarbonic esters thereof and the acyl chlorides of aromatic monocarboxylic acids, which may optionally be substituted by C₁ to C₂₂ alkyl groups or by halogen atoms, and aliphatic C₂ to C₂₂ monocarbonyl chlorides.

The amount of chain terminators is in each case 0.1 to 10 mol %, based on moles of diphenol in the case of phenolic chain terminators and on moles of dicarbonyl dichloride in the case of monocarbonyl chloride chain terminators.

For the production of aromatic polyestercarbonates it is additionally possible to use one or more aromatic hydroxycarboxylic acids.

The aromatic polyestercarbonates may be linear or they may be branched in a known manner (see DE-A 2 940 024 and DE-A 3 007 934), but preference is given to linear polyestercarbonates.

Branching agents used may for example be tri- or polyfunctional carbonyl chlorides, such as trimesoyl trichloride, cyanuric trichloride, 3,3′,4,4′-benzophenonetetracarbonyl tetrachloride, 1,4,5,8-naphthalenetetracarbonyl tetrachloride or pyromellitic tetrachloride, or tri- or polyfunctional phenols, such as phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxy-phenyl)ethane, tri(4-hydroxyphenyl)phenylmethane, 2,2-bis[4,4-bis(4-hydroxyphenyl)cyclohexyll-propane, 2,4-bis(4-hydroxyphenylisopropyl)phenol, tetra(4-hydroxyphenyl)methane, 2,6-bis(2-hydroxy-5-methylbenzyl)-4-methylphenol, 2-(4-hydroxyphenyl)-2-(2,4-dihydroxyphenyl)propane, tetra(4-[4-hydroxyphenylisopropyllphenoxy)methane, 1,4-bis[4,4′-dihydroxytriphenyl)methyll-benzene, in amounts of 0.01 to 1.0 mol % based on diphenols used. Phenolic branching agents may be initially charged with the diphenols. Acyl chloride branching agents may be introduced together with the acyl dichlorides.

The proportion of carbonate structural units in the thermoplastic aromatic polyestercarbonates may be varied as desired. The proportion of carbonate groups is preferably up to 99.9 mol %, in particular up to 80 mol %, more preferably up to 50 mol %, based on the sum total of ester groups and carbonate groups. Both the ester fraction and the carbonate fraction of the aromatic polyestercarbonates may be present in the polycondensate in the form of blocks or in a random distribution.

In a preferred embodiment, suitable polyesters are aromatic, more preferably these are polyalkylene terephthalates. In a particularly preferred embodiment, they are reaction products of aromatic dicarboxylic acids or reactive derivatives thereof, such as dimethyl esters or anhydrides, and aliphatic, cycloaliphatic or araliphatic diols and also mixtures of these reaction products.

Particularly preferred aromatic polyalkylene terephthalates contain at least 80% by weight, preferably at least 90% by weight, based on the dicarboxylic acid component, of terephthalic acid moieties and at least 80% by weight, preferably at least 90% by weight, based on the diol component, of ethylene glycol moieties and/or butane-1,4-diol moieties.

In addition to terephthalic acid moieties, the preferred aromatic polyalkylene terephthalates may contain up to 20 mol %, preferably up to 10 mol %, of other aromatic or cycloaliphatic dicarboxylic acid moieties having 8 to 14 carbon atoms or of aliphatic dicarboxylic acids having 4 to 12 carbon atoms, for example phthalic acid, isophthalic acid, naphthalene-2,6-dicarboxylic acid, 4,4′-diphenyldicarboxylic acid, succinic acid, adipic acid, sebacic acid, azelaic acid or cyclohexanediacetic acid moieties.

In addition to ethylene glycol and/or butane-1,4-diol moieties, the preferred aromatic polyalkylene terephthalates may contain up to 20 mol %, preferably up to 10 mol %, of other aliphatic diols having 3 to 12 carbon atoms or cycloaliphatic diols having 6 to 21 carbon atoms, for example propane-1,3-diol, 2-ethylpropane-1,3-diol, neopentyl glycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di(β-hydroxyethoxy)-benzene, 2,2-bis(4-hydroxycyclohexyl)propane, 2,4-dihydroxy-1,1,3,3-tetramethylcyclobutane, 2,2-bis(4-β-hydroxyethoxyphenyl)propane or 2,2-bis(4-hydroxypropoxyphenyl)propane moieties (DE-A 2 407 674, 2 407 776, 2 715 932).

Particular preference is given to aromatic polyalkylene terephthalates produced solely from terephthalic acid and reactive derivatives thereof (for example the dialkyl esters thereof) and ethylene glycol and/or butane-1,4-diol, and to mixtures of these polyalkylene terephthalates.

Preferred mixtures of aromatic polyalkylene terephthalates contain 1% to 50% by weight, preferably 1% to 30% by weight, of polyethylene terephthalate and 50% to 99% by weight, preferably 70% to 99% by weight, of polybutylene terephthalate.

The aromatic polyalkylene terephthalates can be produced by known methods (see for example Kunststoff-Handbuch [Plastics Handbook], volume VIII, p. 695 ff., Carl-Hanser-Verlag, Munich 1973).

In one embodiment of the present invention, amorphous and/or semicrystalline polyamides are used as the polycondensation polymers. Suitable polyamides are aliphatic polyamides, for example PA-6, PA-11, PA-12, PA-4,6, PA-4,8, PA-4,10, PA-4,12, PA-6,6, PA-6,9, PA-6,10, PA-6,12, PA-10,10, PA-12,12, PA-6/6,6 copolyamide, PA-6/12 copolyamide, PA-6/11 copolyamide, PA-6,6/11 copolyamide, PA-6,6/12 copolyamide, PA-6/6,10 copolyamide, PA-6,6/6,10 copolyamide, PA-4,6/6 copolyamide, PA-6/6,6/6,10 terpolyamide, and copolyamide formed from cyclohexane-1,4-dicarboxylic acid and 2,2,4- and 2,4,4-trimethylhexamethylenediamine, aromatic polyamides, for example PA-6,1, PA-6,1/6,6 copolyamide, PA-6,T, PA-6,T/6 copolyamide, PA-6,T/6,6 copolyamide, PA-6,1/6,T copolyamide, PA-6,6/6,T/6,1 copolyamide, PA-6,T/2-MPMDT copolyamide (2-MPMDT=2-methylpentamethylenediamine), PA-9,T, copolyamide formed from terephthalic acid, 2,2,4- and 2,4,4-trimethylhexamethylenediamine, copolyamide formed from isophthalic acid, laurolactam and 3,5-dimethyl-4,4-diaminodicyclohexylmethane, copolyamide formed from isophthalic acid, azelaic acid and/or sebacic acid and 4,4-diaminodicyclohexylmethane, copolyamide formed from caprolactam, isophthalic acid and/or terephthalic acid and 4,4-diaminodicyclohexylmethane, copolyamide formed from caprolactam, isophthalic acid and/or terephthalic acid and isophoronediamine, copolyamide formed from isophthalic acid and/or terephthalic acid and/or further aromatic or aliphatic dicarboxylic acids, optionally alkyl-substituted hexamethylenediamine and alkyl-substituted 4,4-diaminodicyclohexylamine or copolyamides thereof, and mixtures of the aforementioned polyamides.

Preference is given to using linear polycarbonate based exclusively on bisphenol A as the polycondensation polymer.

### Vinyl (Co)Polymer

The vinyl (co)polymer of the invention is a polymer of one or more vinyl monomers preferably selected from styrene, styrene derivatives, acrylonitrile, acrylic esters, acrylic ester derivatives, olefins, maleimide, and maleimide derivatives.

In the context of the present invention, vinyl (co)polymers are understood as meaning also polymers of one or more vinyl monomers that additionally contain graft-active units incorporated into the polymer chain as comonomers or end groups and/or grafted onto the polymer chain. The number of these graft-active units determines the characteristic nₛ of the invention.

Examples of suitable styrene derivatives include α-methylstyrene and ring-substituted vinyl aromatics such as p-methylstyrene and p-chlorostyrene.

Examples of acrylic esters and acrylic ester derivatives are C₁-C_{B} alkyl (meth)acrylates such as methyl methacrylate, n-butyl acrylate and tert-butyl acrylate, and glycidyl methacrylate.

Examples of vinyl cyanides include acrylonitrile and methacrylonitrile.

Depending on which of the production processes described below is used for the graft copolymers of the invention, it may be necessary to use for the coupling reaction, at least in part, a vinyl monomer having reactive groups, for example hydroxyl groups, carboxyl groups, amino groups or groups containing double bonds, for example vinyl, allyl or acryloyl, carbonyl, nitrile, ester or epoxy groups. Preference is given to using epoxy groups, and more preferably glycidyl methacrylate is used as at least one of the vinyl monomers. In the reaction, the glycidyl methacrylate may be either incorporated through polymerization into the main chain of the vinyl (co)polymer or grafted as a side group onto the main chain of the vinyl (co)polymer. Preferably, the glycidyl methacrylate is incorporated through polymerization into the main chain of the vinyl (co)polymer.

Other suitable vinyl (co)polymers are (co)polymers of
B.1 50% to 99% by weight, preferably 65% to 85% by weight, more preferably 70% to 80% by weight, based on (co)polymer B, of at least one monomer selected from the group comprising vinylaromatics, ring-substituted vinylaromatics and C₁-C_{B} alkyl (meth)acrylates and
B.2 1% to 50% by weight, preferably 15% to 35% by weight, more preferably 20% to 30% by weight, based on (co)polymer B, of at least one monomer selected from the group comprising vinyl cyanides and C₁-C_{B} alkyl (meth)acrylates.

The vinyl (co)polymers are known and can be produced for example by free-radical polymerization, especially by emulsion, suspension, solution or bulk polymerization.

Polyolefins are likewise produced by chain polymerization, for example by free-radical or anionic polymerization. Alkenes are used as monomers here. An alternative name for alkenes is olefins. The monomers may be polymerized individually or as a mixture of various monomers. Preferred monomers are ethylene, propylene, 1-butane, isobutene, 1-pentene, 1-heptene, 1-octene, and 4-methyl-1-pentene.

The polyolefins may contain up to 50% by weight, more preferably up to 30% by weight, of further vinylic comonomers, for example and preferably methyl acrylate, ethyl acrylate, butyl acrylate, glycidyl methacrylate, and methyl methacrylate.

The polyolefins may be amorphous or semicrystalline. They may be linear or branched. The production of polyolefins has long been known to those skilled in the art.

The polymerization may be carried out for example at pressures of from 1 to 3000 bar and temperatures between 20° C. and 300° C., optionally with use of a catalyst system. Examples of suitable catalysts include mixtures of titanium and aluminum compounds, and metallocenes.

By altering the polymerization conditions and the catalyst system, the number of branches, the crystallinity, and the density of the polyolefins can be varied within wide ranges. These measures are also familiar to those skilled in the art.

### Production of the Graft Copolymers of the Invention

Graft copolymerization is a technique for producing polymers in which the main chain forms the starting point for further chains of a different monomer type. Thus, this results in the formation of a copolymer B-(A)ₙₛ on the main chain B of which are connected in a comb-like manner a plurality of chains A formed from a further monomer type, where nₛ indicates the number of these chains. The main chain A is in the context of the present invention also referred to as the backbone and the chains B as side chains or graft branches.

With regard to the present invention, the process by which the graft copolymer structures of the invention are produced is of no consequence, that is to say all graft copolymerization processes known to those skilled in the art are in principle suitable for the production of such graft copolymers of the invention, provided they achieve the claimed product features.

Those skilled in the art are for example familiar in particular with the following three graft copolymerization processes suitable in principle for the production of graft copolymers of the invention:

### “Grafting To” Process:

A polymer is exposed to high-energy electromagnetic radiation (for example gamma radiation), which generates free radicals along the backbone, which then form the starting point for further free-radical polymerization with extension of the second polymer. As an alternative to high-energy electromagnetic radiation, free-radical formers can also be used to generate free radicals along the backbone of the first polymer. At the elevated temperature of the grafting reaction or alternatively under the influence of higher-energy electromagnetic radiation (for example UV radiation), such free-radical formers break down with the formation of free radicals, which in turn can generate free radicals through abstraction of, for example, hydrogen atoms from the backbone of the first polymer along its main chain or at side groups of the polymer, which then form the starting point for further free-radical polymerization with extension of the second polymer. Examples of preferred free-radical formers are azo compounds such as azoisobutyronitrile (AIBN) and organic or inorganic peroxides such as dibenzoyl peroxide (DBPO) or alkali metal peroxodisulfates. Such graft polymerization processes can in principle be carried out in a solution, emulsion or suspension of the first polymer, in a melt of the first polymer, or in the first polymer in solid form. In the latter case, the monomers from which the second polymer forming the graft branches is formed are allowed to soak into the solid of the first polymer and then brought to polymerization.

In an alternative process, an existing polymer and the monomer to be added are dissolved in a nonpolar solvent (for example dichloromethane) and treated with a Lewis acid (coinitiator). The Lewis acid then removes electrons from the polymer at a plurality of sites. The resulting positively charged sites then constitute the starting point for cationic polymerization with the monomer, which forms the graft branches.

### “Grafting From” Process:

In this process, reactive functional groups, for example hydroxyl groups, carboxyl groups, amino groups or groups containing double bonds, for example vinyl, allyl or acryloyl, carbonyl, nitrile, ester or epoxy groups are incorporated into the backbone of the fast polymer along its main chain or into any side groups present. This can be done through copolymerization with monomers containing such functional groups or through subsequent chemical treatment of the backbone polymer. These reactive functional groups in the backbone polymer can then form points of attack for a graft copolymerization with construction of the graft branches from monomeric units. Depending on the functional group, various polymerization processes such as polycondensation, polyaddition or free-radical, anionic or cationic polymerization are suitable for the construction of the graft branches.

### Grafting Process Via

In this process, polymer blocks furnished with reactive groups both in the graft backbone and in the side chains are in a first step produced via polymerization processes generally known to those skilled in the art, for example polycondensation, polyaddition or free-radical, anionic or cationic polymerization, and these two reactive polymers (macromonomers) are in a second step chemically coupled to one another with the formation of the graft copolymer.

The chemical coupling reaction can be carried out either in a solution with a solvent suitable for the two polymers undergoing coupling or in a melt mixture of the two polymers. The melt reaction is preferred on environmental grounds, since it requires no solvent. Melt reactions of this kind may be carried out for example in stirred-tank reactors, in continuous tubular reactors equipped with mixing devices, or preferably in commercially available compounding units such as twin-screw extruders, planetary roller extruders or internal kneaders and also, likewise preferably, in Filmtruders, at temperatures above the melting temperatures of the two polymers undergoing coupling.

Examples of reactive groups suitable for the coupling reaction in this case too are hydroxyl groups, carboxyl groups, amino groups or groups containing double bonds, for example vinyl, allyl or acryloyl, carbonyl, nitrile, ester or epoxy groups, where the functional groups in the two types of polymer blocks that respectively form the backbone and the graft branches in the graft copolymer, must be matched to one another in a pairwise manner so that they permit a coupling reaction, preferably in the form of a condensation or addition reaction, more preferably an addition reaction. Preference is given here to, for example, combinations of hydroxyl, amino or carboxy groups as the functionalization of the fast polymer and epoxy groups as the functionalization of the second polymer, more preferably combinations of amino or carboxy groups as the functionalization of the first polymer and epoxy groups as the functionalization of the second polymer. Where the polycondensation polymer is a polycarbonate, a polyester or a polyestercarbonate, particular preference is given to using combinations of carboxy groups as the functionalization of the fast polymer and epoxy groups as the functionalization of the second polymer. It is further preferable here that the polycarbonate, polyester or polyestercarbonate is functionalized with carboxy groups and the vinyl (co)polymer with epoxy groups.

The functional groups in the polymer that forms the graft branches are preferably introduced terminally. The macromonomers used for the formation of the graft branches are preferably polymer blocks containing only a low proportion of polyfunctionalized polymer molecules, i.e. polymer molecules having more than one reactive functional group. The polymers used for the formation of the graft branches particularly preferably contain a numerical average of not more than 1.5, further preferably not more than 1.3, most preferably not more than 1.1, reactive functional groups per polymer molecule. The polymers used for the formation of the graft branches most preferably contain only a terminal functional group. This makes it possible to minimize the number of branching structures in the graft copolymer and to prevent the formation of such undesirable structures.

Production to form graft branches of particularly preferred carboxy-terminated polycarbonates and polyestercarbonates is carried out for example as described in U.S. Pat. No. 4,959,411. For the formation of carboxy-functionalized end groups, use is made here of carboxy-functionalized phenols or preferably derivatives thereof, especially esters of carboxy-functionalized phenols, more preferably tert-butyl esters of carboxy-functionalized phenols, most preferably tert-butyl 4-hydroxybenzoate as chain terminator in the polycondensation reaction giving rise to the polycarbonate or polyestercarbonate, preferably carried out in an interfacial phosgenation of bisphenols. In the preferred case of the use of tert-butyl esters of carboxy-functionalized phenols as an end-group-forming chain terminator, the terminal carboxy groups are liberated in a subsequent thermal pyrolysis step in which isobutylene is eliminated at temperatures above 200° C. and removed from the reaction mixture under reduced pressure to shift the chemical equilibrium.

Whereas in the polymers disclosed in U.S. Pat. No. 4,959,411 only carboxy-functionalized phenols or preferably derivatives thereof, especially esters of carboxy-functionalized phenols, are used as chain terminators, thereby forming doubly terminally functionalized polycarbonates, for the production of polymer blocks particularly suitable for the formation of the graft branches in the context of the present invention it is recommended to use as chain terminators mixtures of such carboxy-functionalized phenols or preferably derivatives thereof, especially esters of carboxy-functionalized phenols with non-reactively functionalized phenols, for example tert-butylphenol or phenol. This allows the average carboxy functionality of the resulting polycarbonate blocks to be reduced to the desired level previously described. In these chain-terminator mixtures, the non-reactive phenols are preferably used in a molar proportion of at least 50 mol %, further preferably at least 65 mol %, more preferably at least 70 mol %, more preferably at least 75 mol %.

The production of graft copolymers of the invention from these carboxy- or carboxy-derivative-functionalized polycarbonates thus produced can be carried out according to the method likewise described in U.S. Pat. No. 4,959,411 by coupling with the epoxy functionalities of glycidyl methacrylate-grafted polymers or with the epoxy fnnctionalities of vinyl (co)polymers containing structural units derived from glycidyl methacrylate. If using such glycidyl methacrylate-grafted polymers or vinyl (co)polymers containing structural units derived from glycidyl methacrylate as the graft backbone in the production of the graft copolymer, the number of graft branches nₛ in the resulting graft copolymer can be accurately controlled through a suitable choice of ratio of molar amounts of glycidyl methacrylate and non-reactive vinyl monomers. The production of such glycidyl methacrylate-modified polymers is generally known to those skilled in the art. Corresponding commercial products are commercially available under brand names such as Fine-Blend™ SAG and Fine-Blend™ SOG (both Fine-Blend Polymer Shanghai Co., Ltd.) or Lotader™ AX (Arkema).

The particularly preferred doubly terminally grafted and centrally grafted graft copolymers can in principle be produced by chemical coupling of macromonomers according to the same process as previously described; in this specific embodiment of the invention, block copolymers are then used as the graft backbone, preferably block copolymers consisting of blocks of vinyl (co)polymers.

In the case of production of a doubly terminally grafted graft copolymer, a block copolymer containing at least three blocks is used as the graft backbone, wherein only the two outer blocks of the block copolymer are furnished with reactive functional groups in accordance with the abovementioned preferred ranges and wherein, at the center of the block copolymer, which serves as the graft backbone, there is a section consisting of at least one block that does not contain functional groups suitable for coupling with the graft branch blocks.

In the case of production of a centrally grafted graft copolymer, a block copolymer comprising at least three blocks serves as the graft backbone, wherein the two outer sections of the block copolymer each consist of at least one block that does not contain functional groups suitable for coupling with the graft branch blocks, and in the central section of the block copolymer a block is employed that is furnished with reactive functional groups in accordance with the abovementioned preferred ranges.

The blocks furnished with reactive functional groups that are used here are preferably copolymers, more preferably random copolymers, of glycidyl methacrylate and at least one further vinyl monomer.

The production of such block copolymers suitable as the graft backbone for the production of centrally grafted and/or doubly terminally grafted copolymers is known in principle to those skilled in the art. For the production of such structurally defined block copolymers from blocks of differing chemical composition, preference is given to using controlled polymerization processes (often also referred to as “living” polymerizations). Suitable in principle are living anionic polymerization, living cationic polymerization, living ring-opening metathesis polymerization, living free-radical polymerization, and living polycondensation. Preference is given to using a living free-radical polymerization process, more preferably atom-transfer radical polymerization (ATRP) or reversible addition-fragmentation chain transfer (RAFT).

Controlled (“living”) polymerization is understood as meaning polymerizations in which chain termination reactions and chain transfers do not occur and the rate of the chain start reaction is much greater than the rate of the chain extension reaction. This makes it possible to control molar masses having a narrow distribution as well as the production of chemically defined polymer structures, such as specific block copolymers having well-defined sequence lengths and block compositions. The block copolymers are here built up in a number of steps using different monomers or monomer mixtures in each step.

A block copolymer composed of, for example, styrene-derived structural units that is suitable as the graft backbone for the production of a centrally grafted graft copolymer can thus be produced for example by one of the abovementioned living polymerization processes, for example by ATRP, by, in a fast step, initially polymerizing just styrene up to the desired chain length and then, in a second step, polymerizing a mixture of styrene and glycidyl methacrylate onto the polymer from step 1 and lastly, in a third step, again polymerizing pure styrene onto the polymer from step 2, the molar ratio of styrene and glycidyl methacrylate in step 2 making it possible to define the distance apart of two graft branches in the centrally grafted graft copolymer.

A block copolymer composed of, for example, styrene-derived structural units that is suitable as the graft backbone for the production of a doubly terminally grafted graft copolymer can thus be produced in an analogous manner for example by one of the abovementioned living polymerization processes, for example by ATRP, by, in a first step, initially polymerizing a mixture of styrene and glycidyl methacrylate up to the desired chain length and then, in a second step, polymerizing a block of pure styrene onto the polymer from step 1 and lastly, in a third step, again polymerizing a mixture of styrene and glycidyl methacrylate onto the polymer from step 2, the molar ratio of styrene and glycidyl methacrylate in steps 1 and 3 making it possible to define the distance between two graft branches in the two terminal blocks. The chosen proportions of styrene and glycidyl methacrylate in the two terminal blocks can be equal or different and the block lengths of the three blocks can likewise be configured independently of one another.

### Experimental Determination of the Structural Features of the Graft Copolymers of the Invention

The structural features of the graft copolymers of the invention can be determined analytically in a multistep process.

The structural features of graft copolymers of the invention in which the graft backbone is a vinyl (co)polymer and the side chains are a polycondensation polymer can be determined for example by means of an analytical process consisting of the following steps:
1.) Determination of the chemical composition, that is to say the nature and monomer composition of blocks A and B of the graft copolymer, by nuclear magnetic resonance spectroscopy (NMR), more particularly ¹H NMR and/or ¹³C NMR. The solvent here is selected according to the particular graft copolymer. Particularly in the case of graft copolymers of blocks A and B having greatly divergent polarities, for example B=polyolefin and A=aromatic polycarbonate, it is often necessary to carry out the NMR spectroscopy at high temperatures >60° C. in order to completely dissolve the graft copolymer. Suitable for this purpose are preferably multiply chlorinated solvents such as deuterated dichloroethane, deuterated tetrachloroethane, tetrachloromethane or deuterated di-, in- or tetrachlorobenzene.
2.) Determination, from the NMR spectroscopic data obtained in step 1, of the proportion by weight x_{A} of the blocks of polymer A in the graft copolymer.
3.) Determination of the number nₛ of graft branches by NMR spectroscopy, more particularly ¹H NMR and/or ¹³C NMR, from the intensity of NMR signals either assigned to the carbon atoms directly involved in the covalent graft bond or adjacent to this graft bond or to the protons adjacent to the covalent graft bond.
4.) Determination of the molecular weight distribution of the graft copolymer by gel-permeation chromatography (GPC) and determination therefrom of the number-average molecular weight Mₙ, where the GPC data determined for the graft copolymer are evaluated with calibration against the two polymers A and B as standard, with determination of the values Mₙ(A) and Mₙ(B), where M and M are the molecular weights calibrated against polymer A and B standards, and the value Mₙ of the graft copolymer is calculated therefrom according to the formula Mₙ=X_{A}·M_{n,A}+(1−x_{A})·M_{nB}. In the case of GPC too it is often necessary, particularly in the case of graft copolymers of blocks A and B having greatly divergent polarities, for example B=polyolefin and A=aromatic polycarbonate, to carry out the investigation at high temperatures >60° C. in order to completely dissolve the graft copolymer. Solvents suitable for this purpose are for example and preferably the same as for the NMR spectroscopy in step 1, although the use of deuterated solvents is not required for GPC.
5.) Basic saponification, or acid- or base-catalyzed complete hydrolysis of the polycondensation blocks (i.e. complete retrocleavage of the polycondensation polymer components into the monomeric units from which they are formed) and separation of the residual intact vinyl (co)polymer block (graft backbone) by precipitation with subsequent washing and drying. The retrocleavage of the polycondensation polymer components into the monomeric units is preferably carried out by basic saponification in, for example, ethanolic potassium hydroxide solution at elevated temperature, preferably under reflex.
6.) Determination by gel-permeation chromatography (GPC) of the molecular weight distribution of the vinyl (co)polymer block (graft backbone) separated in step 5 and determination therefrom of the number-average molecular weight Mₙ(B), with the GPC measurement calibrated against the respective vinyl (co)polymer in the graft copolymer as standard. The solvent here is selected according to the particular vinyl (co)polymer. For example, for polystyrene, polymethyl methacrylate or styrene-acrylonitrile copolymers (SAN) that in each case contain glycidyl methacrylate as graft-active site as comonomer or termonomer unit, preference is given to dichloromethane or chloroform as solvent. In these cases, GPC at room temperature is usually possible and is preferred. For polyolefins on the other hand, especially for semicrystalline polyolefins and polyolefins of higher molecular weight, it is often necessary to carry out the GPC at high temperatures >60° C. in order to completely dissolve the graft copolymer. Suitable for this purpose are preferably multiply chlorinated solvents such as dichloroethane, tetrachloroethane, tetrachloromethane or di-, In- or tetrachlorobenzene, especially ortho-dichlorobenzene.
7.) Calculation of the value for nₛ·Mₙ(A) from the value for Mₙ determined in step 4 and the value for Mₙ(B) determined in step 6 via the equation nₛ·Mₙ(A)=Mₙ−Mₙ(B) and calculation of the value for Mₙ(A) by dividing this variable nₛ·Mₙ(A) by the value for nₛ determined in step 3.

For the determination of the structural features of graft copolymers of the invention in which the graft backbone is the polycondensation polymer and the side chains are the vinyl (co)polymer, a similar analytical process can be used that does not differ from the above process in steps 1.) to 4.), but where step 4.) is followed by the following steps:
5.) Basic saponification, or acid- or base-catalyzed complete hydrolysis of the polycondensation block, i.e. complete retrocleavage of the graft backbone into its monomeric units, in analogous manner to the case described above and subsequent separation of the residual intact vinyl (co)polymer blocks (graft branches) by precipitation with subsequent washing and drying.
6.) Determination by gel-permeation chromatography (GPC) of the molecular weight distribution of the vinyl (co)polymer blocks (graft branches) separated in step S and determination therefrom of the number-average molecular weight Mₙ(A), with the GPC measurement calibrated against the respective vinyl (co)polymer in the graft copolymer as standard. The solvent is selected as described above.
7.) Calculation of the value Mₙ(B) via the equation Mₙ(B)=Mₙ−nₛ·Mₙ(A) from the value for Mₙ determined in step 4, the value for Mₙ(A) determined in step 6, and the value for nₛ determined in step 3.

In the case of graft copolymers consisting of blocks of aromatic polycarbonate and blocks of polyolefin, the NMR and GPC measurements on the graft polymer and on the polyolefin blocks optionally containing graft-active units are carried out preferably in (deuterated) ortho-dichlorobenzene at a temperature of 80° C.

In the case of graft copolymers consisting of blocks of aromatic polycarbonate and blocks of a polymer selected from polystyrene, polymethyl methacrylate, and styrene-acrylonitrile copolymers optionally containing graft-active units, the NMR measurements are preferably carried out in deuterated dichloromethane at room temperature.

The GPC measurements on the graft copolymer are preferably carried out in dichloromethane at room temperature and the GPC measurements on the vinyl (co)polymer blocks in tetrahydrofuran at room temperature.

### Production of Molding Compounds

Molding compounds can be produced from the graft copolymers of the invention and further components such as homopolymers A and B or polymers having a polarity/chemical structure similar to those of homopolymers A and B and optionally further components.

The thermoplastic molding compounds of the invention may be produced for example by mixing the respective constituents of the compositions in a known manner and melt-compounding and melt-extruding at temperatures of preferably 180° C. to 320° C., particularly preferably at 200° C. to 300° C., very particularly preferably at 240° C. to 290° C., in customary apparatuses such as internal kneaders, extruders, and twin-screw extruders for example.

This process is in the context of the present application generally referred to as compounding.

“Molding compound” is thus understood as meaning the product obtained when the constituents of the composition are melt-compounded and melt-extruded.

The individual constituents of the compositions can be mixed in a known manner either successively or simultaneously, and either at about 20° C. (room temperature) or else at higher temperature. This means that, for example, some of the constituents may be metered in via the main intake of an extruder and the remaining constituents supplied later in the compounding process via a side extruder.

The resulting molding compounds are further provided by the present invention.

The molding compounds of the invention may be used to produce molded articles. These may be produced for example by injection molding, extrusion, and blow-molding processes. A further form of processing is the production of molded articles by thermoforming from previously produced sheets or films. The molding compounds of the invention are particularly suitable for processing by extrusion, blow-molding, and thermoforming methods.

It is also possible to meter the constituents of the compositions directly into the conveying extruder of an injection molding machine, to produce the molding compound of the invention in the conveying extruder, and to process the molding compound directly into molded articles through appropriate discharge of said compound into an injection mold (compounding injection molding).

The present invention thus further provides a molded article that is obtainable from a composition of the invention or from a molding compound of the invention or that comprises such a molding compound.

Further embodiments of the present invention are described below:
1. A graft copolymer of the general structure B-(A) consisting of blocks of two polymers A and B of differing chemical composition, wherein one of the polymers is a polycondensation polymer selected from the group consisting of polycarbonates, polyestercarbonates, polyesters, and polyamides and the other polymer is a polymer composed of at least one vinyl monomer,
characterized in that
   (i) the number-average molecular weight of the block of polymer B Mₙ(B) is at least 13 kg/mol, determined by a combination of gel-permeation chromatography and NMR spectroscopy,
   (ii) the number of side chains in the graft copolymer nₛ, determined by NMR spectroscopy, is at least 3 and not more than 15,
   (iii) the number-average molecular weight of the blocks of polymer A Mₙ(A), determined by a combination of gel-permeation chromatography and NMR spectroscopy, is at least 1.5 kg/mol and not more than 15 kg/mol, and
   (iv) nₛ multiplied by Mₙ(A) comes to at least 13 kg/mol.
2. The graft copolymer according to embodiment 1, wherein polymer A is selected from the group consisting of aromatic polycarbonates, aromatic polyestercarbonates, and aromatic polyesters.
3. The graft copolymer according to embodiment 1 or 2, wherein polymer A is an aromatic polycarbonate.
4. The graft copolymer according to any of the preceding embodiments, wherein polymer B is a polymer of one or more different vinyl monomers selected from the group consisting of styrene, styrene derivatives, acrylonitrile, acrylic esters, acrylic ester derivatives, olefins, maleimide, and maleimide derivatives.
5. The graft copolymer according to embodiment 4, wherein the vinyl monomers are selected from the group consisting of styrene, acrylonitrile, methyl methacrylate, glycidyl methacrylate, and olefins.
6. The graft copolymer according to any of the preceding embodiments, wherein nₛ is at least 4.
7. The graft copolymer according to any of the preceding embodiments, wherein nₛ is at least 5.
8. The graft copolymer according to any of the preceding embodiments, wherein Mₙ(A) is at least 3.0 kg/mol.
9. The graft copolymer according to any of the preceding embodiments, wherein Mₙ(B) is at least 20 kg/mol.
10. The graft copolymer according to any of the preceding embodiments, wherein Mₙ(B) is at least 23 kg/mol.
11. The graft copolymer according to any of the preceding embodiments, wherein the following features are present:
   (i) Mₙ(B) is at least 23 kg/mol,
   (ii) nₛ is at least 5,
   (iii) Mₙ(A) is at least 3.0 kg/mol,
   (iv) nₛ multiplied by Mₙ(A) comes to at least 13 kg/mol.
12. The graft copolymer according to any of the preceding embodiments, wherein nₛ is at least 6.
13. The graft copolymer according to any of the preceding embodiments, wherein Mₙ(A) is at least 4.5 kg/mol.
14. The graft copolymer according to any of the preceding claims, wherein the following features are present:
   (i) Mₙ(B) is at least 23 kg/mol,
   (ii) nₛ is at least 6,
   (iii) Mₙ(A) is at least 4.5 kg/mol,
   (iv) nₛ multiplied by Mₙ(A) comes to at least 13 kg/mol.
15. The graft copolymer according to any of the preceding embodiments, wherein Mₙ(A)·nₛ/[Mₙ(B)+Mₙ(A)·nₛ] is in the range from 0.25 to 0.75.
16. The graft copolymer according to any of the preceding embodiments, wherein Mₙ(A)·nₛ/[Mₙ(B)+Mₙ(A)·nₛ] is in the range from 0.40 to 0.70.
17. The graft copolymer according to any of the preceding embodiments, wherein the following features are present:
   (i) Mₙ(B) is at least 23 kg/mol,
   (ii) nₛ is at least 6,
   (iii) Mₙ(A) is at least 4.5 kg/mol,
   (iv) nₛ multiplied by Mₙ(A) comes to at least 13 kg/mol,
   (v) Mₙ(A)·nₛ/[Mₙ(B)+Mₙ(A)·nₛ] is in the range from 0.40 to 0.70.
18. The graft copolymer according to any of the preceding embodiments, wherein Mₙ(A) is at least 5.3 kg/mol.
19. The graft copolymer according to any of the preceding embodiments, wherein Mₙ(B) is at least kg/mol.
20. The graft copolymer according to any of the preceding embodiments, wherein Mₙ(A)·nₛ/[Mₙ(B)+Mₙ(A)·nₛ] is in the range from 0.40 to 0.60.
21. The graft copolymer according to any of the preceding embodiments, wherein nₛ multiplied by Mₙ(A) comes to at least 20 kg/mol.
22. The graft copolymer according to any of the preceding embodiments, wherein nₛ multiplied by Mₙ(A) comes to at least 30 kg/mol.
23. The graft copolymer according to any of the preceding embodiments, wherein nₛ multiplied by Mₙ(A) comes to at least 35 kg/mol.
24. The graft copolymer according to any of the preceding embodiments, wherein nₛ is not more than 12.
25. The graft copolymer according to any of the preceding embodiments, wherein nₛ is not more than 10.
26. The graft copolymer according to any of the preceding embodiments, wherein nₛ is not more than 8.
27. The graft copolymer according to any of the preceding embodiments, wherein Mₙ(A) is not more than 12 kg/mol.
28. The graft copolymer according to any of the preceding embodiments, wherein Mₙ(A) is not more than 9 kg/mol.
29. The graft copolymer according to any of the preceding embodiments, wherein Mₙ(A) is not more than 8 kg/mol.
30. The graft copolymer according to any of the preceding embodiments, wherein Mₙ(B) is not more than 200 kg/mol.
31. The graft copolymer according to any of the preceding embodiments, wherein Mₙ(B) is not more than 100 kg/mol.
32. The graft copolymer according to any of the preceding embodiments, wherein Mₙ(B) is not more than 50 kg/mol.
33. The graft copolymer according to any of the preceding embodiments, wherein nₛ multiplied by Mₙ(A) comes to not more than 120 kg/mol.
34. The graft copolymer according to any of the preceding embodiments, wherein nₛ multiplied by Mₙ(A) comes to not more than 80 kg/mol.
35. The graft copolymer according to any of the preceding embodiments, wherein nₛ multiplied by Mₙ(A) comes to not more than 50 kg/mol.
36. The graft copolymer according to any of the preceding embodiments, wherein the architecture of the graft copolymer is selected from doubly terminally grafted and centrally grafted.
37. The graft copolymer according to any of the preceding embodiments, wherein the architecture of the graft copolymer is centrally grafted.
38. The use of a graft copolymer according to any of the preceding embodiments for reducing the interfacial tension between phases in mixtures comprising polymers A and B or mixtures of polymers having comparable polarity.
39. A polymer composition comprising polymers A and B and, as component C, a graft copolymer according to any of the preceding embodiments 1 to 37, wherein polymers A and B have the same chemical structure as the blocks of polymers A and B in the graft copolymer corresponding to component C.
40. The polymer composition according to embodiment 39, wherein the ratio of the mass fraction of polymer A in the polymer composition, based on the sum total of polymers A and B in the composition, to the mass fraction of the graft branches in the graft copolymer corresponding to component C is 0.6 to 1.4.
41. The polymer composition according to embodiment 40, wherein the ratio is 0.7 to 1.3.
42. The polymer composition according to embodiment 40, wherein the ratio is 0.8 to 1.2.
43. The polymer composition according to any of embodiments 39 to 42, wherein the graft copolymer is used in a concentration of 0.1 to 20% by weight.
44. The polymer composition according to any of embodiments 39 to 42, wherein the graft copolymer is used in a concentration of 1.0 to 10% by weight.
45. The polymer composition according to any of embodiments 39 to 42, wherein the graft copolymer is used in a concentration of 2 to 5% by weight.
46. A molding compound obtained from a composition according to any of embodiments 39 to 45.
47. A molded article comprising a composition according to any of embodiments 39 to 45.
48. A molded article produced from a molding compound according to embodiment 46.

### EXAMPLES

### Simulation of Interfacial Tension

The influence of the structure of a graft copolymer formed from blocks of two different polymers A and B on the interfacial tension at the phase interface in polymer blends composed of the homopolymers A and B was investigated by means of a computer-aided simulation. A dissipative particle dynamics simulation was used. The simulation was performed using the open source program LAMMPS (“LAMMPS—a flexible simulation tool for particle-based materials modeling at the atomic, meso, and continuum scales”, A. P. Thompson, H. M. Aktulga, R. Berger, D. S. Bolintineanu, W. M. Brown, P. S. Crozier, P. J. in′t Veld, A. Kohlmeyer, S. G. Moore, T. D. Nguyen, R. Shan, M. J. Stevens, J. Tranchida, C. Trott, S. J. Plimpton, Comp Phys Comm, 271 (2022) 10817).

The procedure for the simulations performed is shown below. For reasons of linguistic simplification, some explanations are written in the present tense, but it is the procedure that was actually carried out to which reference is made.

In the dissipative particle dynamics (DPD) simulation, comparatively large molecules, in this case polymers, are modeled by beads, which interact through pairwise interaction potentials. One bead in the DPD simulation represents a cluster consisting of two or more monomer units of the polymer. These beads move under the influence of their interaction forces according to Newton's equations of motion. The total force acting on each individual bead is represented by the sum total of the conservative, dissipative, and random forces. The simulation uses as characteristic variables: r_{c} as a unit of length (“cut-off distance”), m as a unit of mass, k_{B}T as a unit of energy (where k_{b} is the Boltnnann constant and T is the temperature), and t_{dpd}=r_{c}\sqrt{m/k_{B}T} as a unit of time.

In the following, the beads from which the homopolymers A and B are formed are referred to as a and b respectively. The same applies to the beads from which the corresponding blocks of the graft copolymers are formed. This gives rise to a simplified characterization of the graft copolymers via three characteristic variables (l_{b}, lₛ, and nₛ). l_{b} is here the number of beads from which the backbone of the graft copolymer is formed and is thus a measure of the molecular weight thereof. lₛ is the number of beads from which a graft branch is formed and is thus a measure of the molecular weight thereof. nₛ is the number of side chains (graft branches) grafted onto the graft copolymer backbone, where, in the simulation, these side chains were, with the exception of the three specific molecular architectures (ii) to (iv) defined below, always grafted in an equidistant distribution over the entire graft copolymer backbone. The terms “graft branch” and “side chain” are used synonymously here.

A specific embodiment of such graft copolymers investigated in the context of the simulations is thus uniformly equidistantly grafted graft copolymers. In such graft copolymers, the graft branches are distributed uniformly equidistantly over the entire graft copolymer backbone. This thus gives rise to a distance between the side chains Iₛₚ (in units of number of beads) that is calculated via the equation

$${I}_{s p} = 1 + [ ( {I}_{b} - {n}_{s} ) / ( {n}_{s} + 1 ) ] .$$

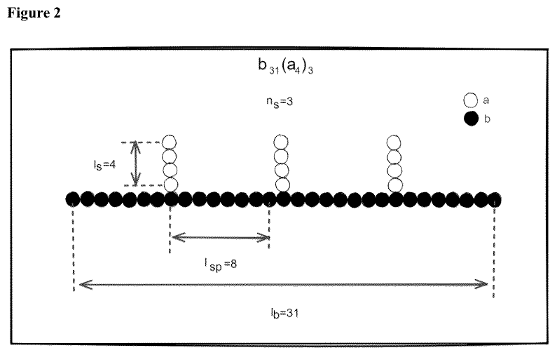

In the context of the examples in the present application, a specific nomenclature has been defined for such uniformly equidistantly grafted graft copolymers: For example, the nomenclature b₃₁(a₄)₃ denotes a graft copolymer that is composed of a graft copolymer backbone consisting of 31 beads of type b, where 3 blocks each formed from 4 beads of type a are grafted onto this copolymer backbone in an equidistant distribution. The architecture of such uniformly equidistantly grafted graft copolymers on which the simulation is based is depicted schematically in FIG. 2 using the example of the graft copolymer b₃₁(a₄)₃. The graft copolymer molecule b₃₁(a₄)₃ depicted by way of example in FIG. 2 thus consists of a total of 31 beads of type b and 3·4=12 beads of type a.

In the DPD simulations carried out in the context of the present invention, the bead size was chosen such that the masses of the beads of type a and b are as similar as is permitted by the molecular masses of the monomer units, i.e. the molecular masses of the beads of type a and b are essentially the same. This accordingly gives rise in the graft copolymer to a mass fraction of polymer blocks A and B that essentially corresponds to the proportion of the beads of type a and b in the graft copolymer. The proportion of type b beads in a graft copolymer molecule consisting of a graft copolymer backbone of polymer A and graft branches of polymer blocks B is calculated according to the equation x=nₛ·lₛ/(l_{b}+nₛ·lₛ).

In the context of the present invention, DPD simulations were performed for different uniformly equidistantly grafted graft copolymers according to the architecture in FIG. 2 with systematically varied values for nₛ, lₛ, and l_{b}.

In addition, graft copolymer architectures were simulated in a comparison with one another in which the molecular weight of the copolymer backbone, the number of graft branches, and the molecular weight of the graft branches were kept constant at l_{b}=47, lₛ=8, and nₛ=11, but the graft branches were arranged, i.e. grafted, in different distributions on the copolymer backbone. In addition to the graft copolymer (i) having the architecture shown in FIG. 1, in which the graft branches are uniformly and equidistantly arranged on the copolymer backbone (“uniformly equidistantly grafted”), graft copolymers each having a distance between side chains of Iₛₚ=1 were simulated: (ii) in which all 11 graft branches were arranged entirely at one end of the graft copolymer backbone (“singly terminally grafted”), (iii) in which respectively 5 and 6 of the total of 11 graft branches were arranged at either end of the graft copolymer backbone (“doubly terminally grafted”), and (iv) in which all 11 graft branches were arranged in the center of the graft copolymer backbone of the graft copolymer (“centrally grafted”). The molecular architectures of these specific three graft copolymers (ii) to (iv) are depicted schematically in FIG. 1 and compared with the architecture of the uniformly equidistantly grafted copolymer (i). As defined by the nomenclature described above, the four graft copolymers (i) to (iv) can be described as shown below, where the square brackets in each case contain a contiguous section of a homopolymer block or graft copolymer block:
(i) b₄₇(a_{B})₁₁
(ii) [b₁₁(a_{B})₁₁]−[b₃₆]
(iii) [b₅(a_{B})₅]−[b₃₆]−[b₆(a_{B})₆₁
(iv) [b₁₈]−[b₁₁(a_{B})₁₁]−[b₁₈]

The simulation of the phase compatibilization efficiency brought about by graft copolymers formed from blocks of polymers A and B in two-phase blends of homopolymers A and B comprised the following process steps:

### 1. Formation of a Start Configuration of the Molecules in the Simulation Box

### Process Step 1 Comprised the Following Two Substeps:

1.1 First, the Cartesian coordinates of one homopolymer molecule each of type A and B and of a graft copolymer molecule formed from blocks of polymers A and B were set via the coordinates of the beads forming these polymers. The initial bond length between two beads was set here at a value of 0.2·r_{c}. During the simulation, the bond length changes under the influence of the interaction forces, i.e. the final bond lengths in the simulated equilibrium state generally do not correspond to the values at the start state of the simulation.

1.2 A total of 162 000 DPD beads were distributed in a periodic box having the dimensions 30×30×60 r_{c}³ in a largely uniformly random manner avoiding molecular overlap. This resulted in a bead density of 3 r_{c}⁻³, which according to general expert experience allows the thermodynamics of fluids to be reflected accurately. The start configuration was depicted here with a distance tolerance of 0.5 r_{c}. In this process step 1.2, the number of homopolymer molecules A and B was chosen such that equal mass concentrations for the two homopolymers resulted, i.e. the simulation is performed in a blend of homopolymers A and B in which the mass fraction of the homopolymers was in each case 50% by weight. The type A and B polymer molecules from process step 1.1 were replicated and each placed in different halves of the simulation box. For the two homopolymers A and B, molecules consisting of in each case 60 beads were used in the simulation. Then n_{c}=200 graft copolymer molecules of the respective architecture were placed close to the interface between homopolymers A and B. This start configuration accelerates the development of a state of thermodynamic equilibrium at the interface during the DPD simulation. In each simulation, all 200 graft copolymer molecules have the same architecture in terms of the values for nₛ, lₛ, and l_{b} selected in each case and of the spatial distribution of the graft branches on the graft backbone.

### 2. Simulation of the Dynamics of the Polymer Molecules Up to a State of Thermodynamic Equilibrium

The positions and impulses of the DPD beads were calculated in discrete time interval steps in the continuous phase space. The motion was simulated here by an algorithm that numerically solves the

$${\dot{r}}_{i} = \frac{{P}_{i}}{{m}_{i}} and {\dot{P}}_{i} = {f}_{i} . \qquad ( 4 )$$

In equation (4), fᵢ is the force acting on the bead i having mass mᵢ due to the sum total of the other beads, and Pᵢ is the impulse of this bead. The stepwise numerical integration of equation (1) was performed using the Verlet algorithm.

The force fᵢ, acting on the bead i due to the totality of the other beads, is here described by equation (5) as the sum total of the pairwise interaction forces Fᵢⱼ of the beads i with the respective other beads j in the simulation box, these pairwise interaction forces including a conservative force component F, a dissipative force component Fᵢⱼ^{D}, and a random force component Fᵢⱼ^{R}:

$${f}_{i} = {\sum }_{i \neq j} ( {F}_{i j}^{C} + {F}_{i j}^{D} + {F}_{i j}^{R} ) \qquad ( 5 )$$

The dissipative force component Fᵢⱼ^{D}=−ηω^{D}(rᵢⱼ)(νᵢⱼeᵢⱼ)eᵢⱼ and the random force component Fᵢⱼ^{R}=σω^{R}(rᵢⱼ)ξᵢⱼΔt^{-1/2}eᵢⱼ together act as a thermostat, wherein η and σ represent the friction parameter and the noise amplitude, where η=σ²/2k_{B}T; rᵢⱼ=rᵢ−rⱼ, νᵢⱼ=νᵢ−vⱼ are the relative velocity of the beads i and j and eᵢⱼ=rᵢⱼ/rᵢⱼ·ω^{D}(rᵢⱼ) and m^{R}(rᵢⱼ) are the positionally-dependent weighting functions for the dissipative and random force components respectively. fᵢⱼ is a Gaussian-distributed random number having an average value of zero for the respective interaction of the beads i and j in each time interval Δt. In the simulations performed in the present application, ω^{D}(rᵢⱼ)=[ω^{R}(rᵢⱼ)]² and σ=3 were chosen. The conservative force component Fᵢⱼ^{C}=αᵢⱼ(1−rᵢⱼ/r_{c})eᵢⱼ(rᵢⱼ<r_{c}) is repulsive and defined by the repulsion parameter aᵢⱼ.

The repulsion parameter between polymers A and B, α_{AB}, can be related to the Flory-Huggins parameter X_{AB} according to equation (6).

$${α}_{A B} = {α}_{A A} + 3.27 {χ}_{A B} \qquad ( 6 )$$

α_{AA} and α_{BB} are here the repulsion parameters of chemically identical molecules, i.e. A with A or B with B, where the value for α_{AA}=α_{BB}=25 k_{B}Tr_{c}⁻¹ employed here is the experience-based representation of the best-possible compressibility of a fluid. A higher value for a_{Ae} here means higher incompatibility of polymer species A and B, i.e. greater repulsion.

In the present application, the binding interactions between two directly adjacent beads of the same polymer molecule were modeled on the basis of simulations via a harmonic spring force Fᵢⱼ^{s}=−Crᵢⱼ, where C=4.0 k_{B}Tr_{c}⁻² is the spring constant of a harmonic oscillator.

The simulation was carried out until constancy over time of the mean-square radius of gyration of the simulation system, this constancy having been chosen as the criterion for reaching a state of equilibrium. On reaching this state of equilibrium, 2×10⁶ further simulation steps were calculated (Δt=0.06t_{dpd}). The equilibrium configuration generated in this way was used in step 4 (as described below) to determine the interfacial tensiony.

### 3. Assignment to a Real Polymer System (Mapping)

Mapping refers to the step of the simulation process in which the beads of type a and b and the repulsion parameters α_{AB} were assigned to real polymer species or oligomeric units of real polymer species.

In the simulation, each bead of which the polymers for the simulation are composed represents an oligomeric unit of the respective polymer, that is to say a structural unit formed from a number n of monomeric units. When a specific real polymer is assigned to the abstract polymer system, the specific value n can be specified for the individual polymer; this value varies for chemically different polymers of different molar mass in the repeat unit. n is determined under the basic condition that the beads of type a and b from which the homopolymers and graft copolymers for the simulation are composed, have approximately the same volume and thus approximately the same mass.

In the second step of mapping, the value for the repulsion parameter a_{AB} of a specific A-B polymer system can be determined from the Flory-Huggins parameter X_{AB} according to equation (6). Once a specific oligomeric unit of the respective polymer A and B formed from n monomeric units had been assigned to each type a and b bead in the fast step of mapping, the value for X_{AB} was determined using the COSMO-RS model. For this, the activity coefficient γ_{A} of A in the mixture was calculated quantum chemically for an equimolar mixture of the oligomeric units formed from n monomeric units of polymers A and B via the COSMO-RS model and with the aid of the Biova COSMOtherm 2019 (Dassault Systemes) software. This activity coefficient γ_{A} was then used to calculate the Flory-Huggins parameter according to equation (7)

$${χ}_{A B} = \frac{{V}_{t o t}}{{x}_{A} {V}_{A}} \sqrt{ln {γ}_{A} - ln ( 1 - \frac{{x}_{A} {V}_{A}}{{V}_{t o t}} ) - ( 1 - \frac{1}{\frac{{V}_{B}}{{V}_{A}}} ) \frac{{x}_{A} {V}_{A}}{{V}_{t o t}}} . \qquad ( 7 )$$

In equation (7) x_{A} represents the molar proportion of A in the mixture (thus in our case x_{A}=0.5), V_{A} and V_{B} are the volumes of species A and B, and Vₜₒₜ=V_{A}+VB.

COSMO-RS (“COnductor like Screening MOdel for Real Solvents”) is a quantum chemistry-based equilibrium thermodynamics simulation method for predicting chemical potentials in fluids that is known to those skilled in the art. Details of the COSMO-RS model and of the application thereof to questions such as those in the present application are known to those skilled in the art, for example from the review article by A. Klamt, “The COSMO and COSMO-RS solvation models”, WIREs Comput Mol Sci 2018, 8:e1338. doi: 10.1002/wcms.1338 and works cited therein.

Using this methodology, two different polymer systems were assigned (mapped) and then subjected to DPD simulations:
System 1: Polymer B (graft backbone)=polystyrene, polymer A (graft branches)=bisphenol A based polycaibonate
System 2: Polymer B (graft backbone)=polypropylene, polymer A (graft branches)=bisphenol A based polycaibonate

For these two systems, the mapping process yielded the values for α_{AB} and molar masses of the type a (Mₐ) and b (M_{b}) beads for a temperature of 100° C. shown in Table 1, which served as the basis for the simulation.

TABLE 1

| Graft | Graft | | | |
|---|---|---|---|---|
| backbone | branches | α_{AB} | M_{b} [g mol⁻¹] | Mₐ [g mol⁻¹] |
| Polystyrene | Polycarbonate | 28 | 668 | 792 |
| Polypropylene | Polycarbonate | 35 | 717 | 792 |

Using the molar masses of the type A and B beads shown in Table 1, the values for the number of beads in the graft backbone l_{b} and in the graft branches lₛ can be converted by multiplication into molar masses of the graft backbone Mₙ(B) and of the graft branches Mₙ(A).

4. Determination of the interfacial tension and efficiency of graft copolymers as phase compatibdizers from the equilibrium configuration in the DPD simulation

The interfacial tension γ was determined from the equilibrium configuration resulting in process step 3 according to equation (8)

$$γ = \frac{{L}_{z}}{2} [ {P}_{zz} - \frac{1}{2} ( {P}_{xx} + {P}_{y y} ) ] . \qquad ( 8 )$$

Pₓₓ, P_{yy} and P_{zz} are here the diagonal components of the pressure tensor, which were calculated according to equation (9)

$${P}_{k k} = \frac{1}{V} ( {Σ}_{i = 1}^{N} {m}_{i} {v}_{i k} {v}_{j k} + {Σ}_{i = 1}^{N - 1} {Σ}_{j = i + 1}^{N} {F}_{i j k} {r}_{i j y} ) , \qquad ( 9 )$$

where N is the total number of beads and V=Lₓ×L_{y}×L_{z} the volume of the simulation box.

The interfacial tension γ₀ determined in analogous manner for the comparable blend of homopolymers A and B in the absence of graft copolymer molecules, i.e. for the uncompatibilized blend, serves as reference in the determination of the phase compatibilizer efficiency E=(1-γ/γ₀) of the respective graft copolymer.

The resulting phase compatibilizer efficiency E is shown in Tables 2 and 3 for different graft copolymer structures. The number of side chains (nₛ), the molecular weight Mₙ(B) of the backbone, and the molecular weight Mₙ(A) of a single side chain were varied here. It is also possible therefrom to calculate in each case molecular weights for the graft copolymers (from Mₙ(B)+nₛ multiplied by Mₙ(A)), Mₙ(A) multiplied by nₛ, and the molar mass fraction in % by weight that the side chains account for in the graft copolymer (mass fraction of graft branches). The simulations were performed for graft copolymers having a backbone either of polystyrene (PS, Table 2) or of polypropylene (PP, Table 3). The side chains are in both cases formed from bisphenol-A-based polycarbonate.

Table 4 shows the influence of the graft architecture according to the designations (i) to (iv) used above in which the molecular weights Mₙ of the backbone and of the side chains are the same in each graft polymer system. All graft copolymers with architectures (i) to (iv) had 11 side chains here. The investigations were performed with both polystyrene and polypropylene as the graft copolymer backbone and in all cases with bisphenol-A-based polycarbonate as side chains.

TABLE 2
Uniformly equidistantly grafted graft copolymers having
polystyrene (PS) as backbone and simulated values for E

| | | | | | Mₙ(A) × nₛ | | | |
|---|---|---|---|---|---|---|---|---|
| | | | | Mₙ(A) | (graft | Mₙ | Mass | |
| | | | Mₙ(B) | (graft | branches, | (graft | fraction of | |
| | | | (backbone) | branch) | total) | copolymer) | graft | |
| No. | Backbone | nₛ | [kg/mol] | [kg/mol] | [kg/mol] | [kg/mol] | branches | E |
| 1 | PS | 6 | 42.1 | 6.3 | 38.0 | 80.1 | 0.47 | 67 |
| 2 | PS | 6 | 31.4 | 6.3 | 38.0 | 69.4 | 0.55 | 63 |
| 3 | PS | 6 | 26.1 | 6.3 | 38.0 | 64.1 | 0.59 | 56 |
| 4 | PS | 11 | 42.1 | 6.3 | 69.7 | 111.8 | 0.62 | 53 |
| 5 | PS | 11 | 20.7 | 5.5 | 61.0 | 81.7 | 0.75 | 51 |
| 6 | PS | 3 | 42.1 | 6.3 | 19.0 | 61.1 | 0.31 | 50 |
| 7 | PS | 7 | 20.7 | 5.5 | 38.8 | 59.5 | 0.65 | 49 |
| 8 | PS | 6 | 20.7 | 6.3 | 38.0 | 58.7 | 0.65 | 48 |
| 9 | PS | 11 | 42.1 | 3.2 | 34.8 | 76.9 | 0.45 | 47 |
| 10 | PS | 9 | 20.7 | 5.5 | 49.9 | 70.6 | 0.71 | 46 |
| 11 | PS | 11 | 31.4 | 6.3 | 69.7 | 101.1 | 0.69 | 45 |
| 12 | PS | 11 | 26.1 | 6.3 | 69.7 | 95.7 | 0.73 | 43 |
| 13 | PS | 11 | 31.4 | 3.2 | 34.8 | 66.2 | 0.53 | 42 |
| 14 | PS | 5 | 20.7 | 5.5 | 27.7 | 48.4 | 0.57 | 42 |
| 15 | PS | 11 | 20.7 | 3.2 | 34.8 | 55.6 | 0.63 | 41 |
| 16 | PS | 6 | 31.4 | 3.2 | 19.0 | 50.4 | 0.38 | 41 |
| 17 | PS | 4 | 20.7 | 6.3 | 25.3 | 46.1 | 0.55 | 41 |
| 18 | PS | 6 | 15.4 | 6.3 | 38.0 | 53.4 | 0.71 | 40 |
| 19 | PS | 11 | 26.1 | 3.2 | 34.8 | 60.9 | 0.57 | 39 |
| 20 | PS | 11 | 20.7 | 6.3 | 69.7 | 90.4 | 0.77 | 38 |
| 21 | PS | 6 | 42.1 | 3.2 | 19.0 | 61.1 | 0.31 | 38 |
| 22 | PS | 3 | 31.4 | 6.3 | 19.0 | 50.4 | 0.38 | 38 |
| 23 | PS | 4 | 20.7 | 7.1 | 28.5 | 49.2 | 0.58 | 38 |
| 24 | PS | 6 | 26.1 | 3.2 | 19.0 | 45.1 | 0.42 | 36 |
| 25 | PS | 4 | 20.7 | 7.9 | 31.7 | 52.4 | 0.60 | 36 |
| 26 | PS | 4 | 20.7 | 5.5 | 22.2 | 42.9 | 0.52 | 36 |
| 27 | PS | 11 | 20.7 | 2.4 | 26.1 | 46.8 | 0.56 | 34 |
| 28 | PS | 6 | 20.7 | 3.2 | 19.0 | 39.7 | 0.48 | 33 |
| 29 | PS | 4 | 20.7 | 4.8 | 19.0 | 39.7 | 0.48 | 33 |
| 30 | PS | 3 | 26.1 | 6.3 | 19.0 | 45.1 | 0.42 | 33 |
| 31 | PS | 7 | 20.7 | 2.4 | 16.6 | 37.3 | 0.45 | 33 |
| 32 | PS | 11 | 42.1 | 1.6 | 17.4 | 59.5 | 0.29 | 32 |
| 33 | PS | 9 | 20.7 | 2.4 | 21.4 | 42.1 | 0.51 | 32 |
| 34 | PS | 11 | 31.4 | 1.6 | 17.4 | 48.8 | 0.36 | 32 |
| 35 | PS | 3 | 20.7 | 6.3 | 19.0 | 39.7 | 0.48 | 31 |
| 36 | PS | 6 | 15.4 | 3.2 | 19.0 | 34.4 | 0.55 | 30 |
| 37 | PS | 3 | 15.4 | 6.3 | 19.0 | 34.4 | 0.55 | 30 |
| 38 | PS | 11 | 15.4 | 6.3 | 69.7 | 85.1 | 0.82 | 30 |
| 39 | PS | 4 | 20.7 | 4.0 | 15.8 | 36.5 | 0.43 | 30 |
| 40 | PS | 11 | 20.7 | 1.6 | 17.4 | 38.1 | 0.46 | 30 |
| V41 | PS | 6 | 10.0 | 6.3 | 38.0 | 48.0 | 0.79 | 27 |
| V42 | PS | 3 | 42.1 | 3.2 | 9.5 | 51.6 | 0.18 | 27 |
| V43 | PS | 1 | 42.1 | 6.3 | 6.3 | 48.4 | 0.13 | 27 |
| V44 | PS | 3 | 26.1 | 3.2 | 9.5 | 35.6 | 0.27 | 27 |
| V45 | PS | 3 | 31.4 | 3.2 | 9.5 | 40.9 | 0.23 | 26 |
| V46 | PS | 3 | 15.4 | 3.2 | 9.5 | 24.9 | 0.38 | 26 |
| V47 | PS | 6 | 10.0 | 1.6 | 9.5 | 19.5 | 0.49 | 24 |
| V48 | PS | 4 | 20.7 | 3.2 | 12.7 | 33.4 | 0.38 | 24 |
| V49 | PS | 6 | 42.1 | 1.6 | 9.5 | 51.6 | 0.18 | 23 |
| V50 | PS | 6 | 10.0 | 3.2 | 19.0 | 29.0 | 0.65 | 23 |
| V51 | PS | 11 | 10.0 | 1.6 | 17.4 | 27.4 | 0.63 | 23 |
| V52 | PS | 11 | 20.7 | 0.8 | 8.7 | 29.4 | 0.30 | 22 |
| V53 | PS | 6 | 7.3 | 3.2 | 19.0 | 26.4 | 0.72 | 22 |
| V54 | PS | 4 | 7.3 | 4.8 | 19.0 | 26.4 | 0.72 | 22 |
| V55 | PS | 1 | 31.4 | 6.3 | 6.3 | 37.7 | 0.17 | 22 |
| V56 | PS | 4 | 7.3 | 7.9 | 31.7 | 39.0 | 0.81 | 22 |
| V57 | PS | 6 | 20.7 | 1.6 | 9.5 | 30.2 | 0.31 | 22 |
| V58 | PS | 3 | 20.7 | 3.2 | 9.5 | 30.2 | 0.31 | 22 |
| V59 | PS | 4 | 20.7 | 2.4 | 9.5 | 30.2 | 0.31 | 22 |
| V60 | PS | 3 | 10.0 | 6.3 | 19.0 | 29.0 | 0.65 | 21 |
| V61 | PS | 3 | 10.0 | 3.2 | 9.5 | 19.5 | 0.49 | 21 |
| V62 | PS | 6 | 31.4 | 1.6 | 9.5 | 40.9 | 0.23 | 21 |
| V63 | PS | 4 | 7.3 | 4.0 | 15.8 | 23.2 | 0.68 | 21 |
| V64 | PS | 4 | 7.3 | 3.2 | 12.7 | 20.0 | 0.63 | 21 |
| V65 | PS | 3 | 7.3 | 3.2 | 9.5 | 16.9 | 0.56 | 21 |
| V66 | PS | 4 | 7.3 | 2.4 | 9.5 | 16.9 | 0.56 | 21 |
| V67 | PS | 6 | 26.1 | 1.6 | 9.5 | 35.6 | 0.27 | 21 |
| V68 | PS | 1 | 7.3 | 6.3 | 6.3 | 13.7 | 0.46 | 21 |
| V69 | PS | 3 | 7.3 | 6.3 | 19.0 | 26.4 | 0.72 | 20 |
| V70 | PS | 1 | 26.1 | 6.3 | 6.3 | 32.4 | 0.20 | 20 |
| V71 | PS | 1 | 15.4 | 6.3 | 6.3 | 21.7 | 0.29 | 20 |
| V72 | PS | 4 | 20.7 | 1.6 | 6.3 | 27.0 | 0.23 | 20 |
| V73 | PS | 3 | 20.7 | 2.4 | 7.1 | 27.8 | 0.26 | 20 |
| V74 | PS | 11 | 10.0 | 3.2 | 34.8 | 44.9 | 0.78 | 20 |
| V75 | PS | 3 | 7.3 | 1.6 | 4.8 | 12.1 | 0.39 | 19 |
| V76 | PS | 6 | 15.4 | 1.6 | 9.5 | 24.9 | 0.38 | 19 |
| V77 | PS | 6 | 7.3 | 6.3 | 38.0 | 45.4 | 0.84 | 18 |
| V78 | PS | 4 | 7.3 | 7.1 | 28.5 | 35.9 | 0.80 | 18 |
| V79 | PS | 7 | 20.7 | 0.8 | 5.5 | 26.3 | 0.21 | 18 |
| V80 | PS | 1 | 10.0 | 6.3 | 6.3 | 16.4 | 0.39 | 17 |
| V81 | PS | 4 | 7.3 | 5.5 | 22.2 | 29.5 | 0.75 | 17 |
| V82 | PS | 1 | 31.4 | 3.2 | 3.2 | 34.6 | 0.09 | 17 |
| V83 | PS | 5 | 20.7 | 0.8 | 4.0 | 24.7 | 0.16 | 16 |
| V84 | PS | 3 | 42.1 | 1.6 | 4.8 | 46.8 | 0.10 | 16 |
| V85 | PS | 4 | 7.3 | 1.6 | 6.3 | 13.7 | 0.46 | 16 |
| V86 | PS | 3 | 26.1 | 1.6 | 4.8 | 30.8 | 0.15 | 16 |
| V87 | PS | 3 | 31.4 | 1.6 | 4.8 | 36.1 | 0.13 | 16 |
| V88 | PS | 1 | 20.7 | 6.3 | 6.3 | 27.0 | 0.23 | 16 |
| V89 | PS | 3 | 10.0 | 1.6 | 4.8 | 14.8 | 0.32 | 16 |
| V90 | PS | 9 | 20.7 | 0.8 | 7.1 | 27.8 | 0.26 | 15 |
| V91 | PS | 1 | 10.0 | 3.2 | 3.2 | 13.2 | 0.24 | 15 |
| V92 | PS | 1 | 20.7 | 3.2 | 3.2 | 23.9 | 0.13 | 15 |
| V93 | PS | 4 | 20.7 | 0.8 | 3.2 | 23.9 | 0.13 | 15 |
| V94 | PS | 1 | 7.3 | 3.2 | 3.2 | 10.5 | 0.30 | 15 |
| V95 | PS | 4 | 7.3 | 0.8 | 3.2 | 10.5 | 0.30 | 15 |
| V96 | PS | 1 | 42.1 | 3.2 | 3.2 | 45.3 | 0.07 | 14 |
| V97 | PS | 11 | 7.3 | 3.2 | 34.8 | 42.2 | 0.83 | 14 |
| V98 | PS | 3 | 15.4 | 1.6 | 4.8 | 20.1 | 0.24 | 14 |
| V99 | PS | 3 | 20.7 | 1.6 | 4.8 | 25.5 | 0.19 | 13 |
| V100 | PS | 4 | 7.3 | 6.3 | 25.3 | 32.7 | 0.78 | 13 |
| V101 | PS | 6 | 7.3 | 1.6 | 9.5 | 16.9 | 0.56 | 13 |
| V102 | PS | 11 | 10.0 | 6.3 | 69.7 | 79.7 | 0.87 | 13 |
| V103 | PS | 11 | 7.3 | 1.6 | 17.4 | 24.8 | 0.70 | 12 |
| V104 | PS | 1 | 26.1 | 3.2 | 3.2 | 29.2 | 0.11 | 12 |
| V105 | PS | 1 | 15.4 | 3.2 | 3.2 | 18.5 | 0.17 | 12 |
| V106 | PS | 11 | 7.3 | 6.3 | 69.7 | 77.0 | 0.90 | 12 |
| V107 | PS | 1 | 20.7 | 2.4 | 2.4 | 23.1 | 0.10 | 11 |
| V108 | PS | 1 | 20.7 | 1.6 | 1.6 | 22.3 | 0.07 | 10 |
| V109 | PS | 1 | 20.7 | 5.5 | 5.5 | 26.3 | 0.21 | 10 |
| V110 | PS | 1 | 26.1 | 1.6 | 1.6 | 27.6 | 0.06 | 10 |
| V111 | PS | 1 | 31.4 | 1.6 | 1.6 | 33.0 | 0.05 | 9 |
| V112 | PS | 3 | 20.7 | 0.8 | 2.4 | 23.1 | 0.10 | 9 |
| V113 | PS | 1 | 10.0 | 1.6 | 1.6 | 11.6 | 0.14 | 9 |
| V114 | PS | 1 | 15.4 | 1.6 | 1.6 | 16.9 | 0.09 | 9 |
| V115 | PS | 1 | 42.1 | 1.6 | 1.6 | 43.7 | 0.04 | 8 |
| V116 | PS | 1 | 7.3 | 1.6 | 1.6 | 8.9 | 0.18 | 5 |
| V117 | PS | 1 | 20.7 | 0.8 | 0.8 | 21.5 | 0.04 | 5 |

TABLE 3
Uniformly equidistantly grafted graft copolymers having
polypropylene (PP) as backbone and simulated values for E

| | | | | | Mₙ(A) × nₛ | | | |
|---|---|---|---|---|---|---|---|---|
| | | | | Mₙ(A) | (graft | Mₙ | Mass | |
| | | | Mₙ(B) | (graft | branches, | (graft | fraction of | |
| | | | (backbone) | branch) | total) | copolymer) | graft | |
| No. | Backbone | nₛ | [kg/mol] | [kg/mol] | [kg/mol] | [kg/mol] | branches | E |
| 118 | PP | 6 | 45.2 | 6.3 | 38.0 | 83.2 | 0.46 | 82 |
| 119 | PP | 11 | 45.2 | 6.3 | 69.7 | 114.9 | 0.61 | 78 |
| 120 | PP | 11 | 22.2 | 5.5 | 61.0 | 83.2 | 0.73 | 77 |
| 121 | PP | 11 | 45.2 | 3.2 | 34.8 | 80.0 | 0.44 | 75 |
| 122 | PP | 9 | 22.2 | 5.5 | 49.9 | 72.1 | 0.69 | 74 |
| 123 | PP | 4 | 22.2 | 7.1 | 28.5 | 50.7 | 0.56 | 73 |
| 124 | PP | 11 | 22.2 | 3.2 | 34.8 | 57.1 | 0.61 | 66 |
| 125 | PP | 4 | 22.2 | 7.9 | 31.7 | 53.9 | 0.59 | 65 |
| 126 | PP | 7 | 22.2 | 5.5 | 38.8 | 61.0 | 0.64 | 63 |
| 127 | PP | 6 | 45.2 | 3.2 | 19.0 | 64.2 | 0.30 | 62 |
| 128 | PP | 4 | 22.2 | 6.3 | 25.3 | 47.6 | 0.53 | 62 |
| 129 | PP | 11 | 22.2 | 6.3 | 69.7 | 91.9 | 0.76 | 58 |
| 130 | PP | 5 | 22.2 | 5.5 | 27.7 | 49.9 | 0.55 | 54 |
| 131 | PP | 11 | 22.2 | 1.6 | 17.4 | 39.7 | 0.44 | 53 |
| 132 | PP | 11 | 45.2 | 1.6 | 17.4 | 62.6 | 0.28 | 53 |
| 133 | PP | 4 | 22.2 | 5.5 | 22.2 | 44.4 | 0.50 | 51 |
| 134 | PP | 6 | 22.2 | 6.3 | 38.0 | 60.2 | 0.63 | 51 |
| 135 | PP | 3 | 22.2 | 5.5 | 16.6 | 38.9 | 0.43 | 46 |
| 136 | PP | 6 | 22.2 | 3.2 | 19.0 | 41.2 | 0.46 | 37 |
| 137 | PP | 4 | 22.2 | 4.8 | 19.0 | 41.2 | 0.46 | 37 |
| 138 | PP | 3 | 45.2 | 6.3 | 19.0 | 64.2 | 0.30 | 31 |
| 139 | PP | 4 | 22.2 | 4.0 | 15.8 | 38.1 | 0.42 | 30 |
| V140 | PP | 3 | 45.2 | 3.2 | 9.5 | 54.7 | 0.17 | 29 |
| V141 | PP | 6 | 7.9 | 6.3 | 38.0 | 45.9 | 0.83 | 29 |
| V142 | PP | 4 | 7.9 | 7.9 | 31.7 | 39.6 | 0.80 | 29 |
| V143 | PP | 6 | 22.2 | 1.6 | 9.5 | 31.7 | 0.30 | 27 |
| V144 | PP | 4 | 7.9 | 7.1 | 28.5 | 36.4 | 0.78 | 27 |
| V145 | PP | 11 | 7.9 | 3.2 | 34.8 | 42.7 | 0.82 | 27 |
| V146 | PP | 4 | 7.9 | 6.3 | 25.3 | 33.2 | 0.76 | 26 |
| V147 | PP | 4 | 7.9 | 5.5 | 22.2 | 30.1 | 0.74 | 24 |
| V148 | PP | 3 | 45.2 | 1.6 | 4.8 | 49.9 | 0.10 | 22 |
| V149 | PP | 4 | 22.2 | 3.2 | 12.7 | 34.9 | 0.36 | 21 |
| V150 | PP | 11 | 7.9 | 1.6 | 17.4 | 25.3 | 0.69 | 20 |
| V151 | PP | 11 | 7.9 | 6.3 | 69.7 | 77.6 | 0.90 | 20 |
| V152 | PP | 6 | 7.9 | 3.2 | 19.0 | 26.9 | 0.71 | 18 |
| V153 | PP | 4 | 7.9 | 4.8 | 19.0 | 26.9 | 0.71 | 18 |
| V154 | PP | 4 | 7.9 | 4.0 | 15.8 | 23.7 | 0.67 | 16 |
| V155 | PP | 6 | 7.9 | 1.6 | 9.5 | 17.4 | 0.55 | 13 |
| V156 | PP | 3 | 7.9 | 6.3 | 19.0 | 26.9 | 0.71 | 13 |
| V157 | PP | 4 | 7.9 | 3.2 | 12.7 | 20.6 | 0.62 | 13 |
| V158 | PP | 3 | 22.2 | 1.6 | 4.8 | 27.0 | 0.18 | 16 |
| V159 | PP | 1 | 45.2 | 6.3 | 6.3 | 51.5 | 0.12 | 12 |
| V160 | PP | 3 | 7.9 | 3.2 | 9.5 | 17.4 | 0.55 | 12 |
| V161 | PP | 3 | 7.9 | 1.6 | 4.8 | 12.6 | 0.38 | 11 |
| V162 | PP | 4 | 7.9 | 1.6 | 6.3 | 14.2 | 0.45 | 11 |
| V163 | PP | 1 | 45.2 | 1.6 | 1.6 | 46.8 | 0.03 | 11 |
| V164 | PP | 1 | 45.2 | 3.2 | 3.2 | 48.3 | 0.07 | 10 |
| V165 | PP | 3 | 22.2 | 3.2 | 9.5 | 31.7 | 0.30 | 16 |
| V166 | PP | 4 | 22.2 | 1.6 | 6.3 | 28.6 | 0.22 | 13 |
| V167 | PP | 1 | 7.9 | 6.3 | 6.3 | 14.2 | 0.45 | 9 |
| V168 | PP | 1 | 22.2 | 6.3 | 6.3 | 28.6 | 0.22 | 12 |
| V169 | PP | 7 | 22.2 | 0.8 | 5.5 | 27.8 | 0.20 | 10 |
| V170 | PP | 1 | 22.2 | 3.2 | 3.2 | 25.4 | 0.12 | 10 |
| V171 | PP | 4 | 7.9 | 0.8 | 3.2 | 11.1 | 0.29 | 8 |
| V172 | PP | 1 | 7.9 | 3.2 | 3.2 | 11.1 | 0.29 | 8 |
| V173 | PP | 1 | 7.9 | 1.6 | 1.6 | 9.5 | 0.17 | 7 |
| V174 | PP | 4 | 22.2 | 0.8 | 3.2 | 25.4 | 0.12 | 10 |
| V175 | PP | 11 | 22.2 | 0.8 | 8.7 | 30.9 | 0.28 | 10 |
| V176 | PP | 9 | 22.2 | 0.8 | 7.1 | 29.4 | 0.24 | 9 |
| V177 | PP | 3 | 22.2 | 0.8 | 2.4 | 24.6 | 0.10 | 9 |
| V178 | PP | 5 | 22.2 | 0.8 | 4.0 | 26.2 | 0.15 | 9 |
| V179 | PP | 1 | 22.2 | 1.6 | 1.6 | 23.8 | 0.07 | 8 |
| V180 | PP | 1 | 22.2 | 5.5 | 5.5 | 27.8 | 0.20 | 5 |
| V181 | PP | 1 | 22.2 | 0.8 | 0.8 | 23.0 | 0.03 | 5 |

TABLE 4
Influence of graft architecture on E

| | | | | | | Mₙ(A) × nₛ | | | |
|---|---|---|---|---|---|---|---|---|---|
| | | | | | Mₙ(A) | (graft | Mₙ | Mass | |
| | | | | Mₙ(B) | (graft | branches, | (graft | fraction | |
| | Graft | | | (backbone) | branch) | total) | copolymer) | of graft | |
| No. | architecture | Backbone | nₛ | [kg/mol] | [kg/mol] | [kg/mol] | [kg/mol] | branches | E |
| 11 | Uniformly | PS | 11 | 31.4 | 6.3 | 69.7 | 101.1 | 0.69 | 45 |
| | equidistantly | | | | | | | | |
| 182 | Singly | PS | 11 | 31.4 | 6.3 | 69.7 | 101.1 | 0.69 | 46 |
| | terminally | | | | | | | | |
| 183 | Centrally | PS | 11 | 31.4 | 6.3 | 69.7 | 101.1 | 0.69 | 78 |
| 184 | Doubly | PS | 11 | 31.4 | 6.3 | 69.7 | 101.1 | 0.69 | 66 |
| | terminally | | | | | | | | |
| 185 | Uniformly | PP | 11 | 33.7 | 6.3 | 69.7 | 103.4 | 0.67 | 72 |
| | equidistantly | | | | | | | | |
| 186 | Singly | PP | 11 | 33.7 | 6.3 | 69.7 | 103.4 | 0.67 | 52 |
| | terminally | | | | | | | | |
| 187 | Centrally | PP | 11 | 33.7 | 6.3 | 69.7 | 103.4 | 0.67 | 88 |
| 188 | Doubly | PP | 11 | 33.7 | 6.3 | 69.7 | 103.4 | 0.67 | 81 |
| | terminally | | | | | | | | |

The data in Tables 2 and 3 show that only the graft copolymer embodiments of the invention exhibit an increased phase compatibilizer efficiency in the sense of a value E=(1−γ/γ₀) of at least 30.

In addition, evaluations of the data in Tables 2 and 3 show that, above a certain value for Mₙ(A), a further increase in the value of this variable no longer brings any significant further improvements in phase compatibilizer efficiency in the sense of a higher value E=(1−γ/γ₀). This is evident for example from a plot of E against Mₙ(A) for all values from Table 2 having a constant Mₙ(B) of for example 20.7 kg/mol and a constant nₛ of for example 4. As mentioned above, it is however desirable that the graft copolymers display their effective effect at the lowest possible molecular weight. It follows therefrom that Mₙ(A) must be no greater than 15 kg/mol in order to achieve the necessary balance between good phase compatibilizer efficiency E and good mobility in the polymer melt and thus swift migration to the phase interface.

Likewise, evaluations of the data in Tables 2 and 3 show that, above a certain value for nₛ, a further increase in the value of this variable no longer brings any significant further improvements in phase compatibilizer efficiency in the sense of a higher value E=(1−γ/γ₀). This is evident for example from a plot of E against nₛ for all values from Table 2 having a constant Mₙ(B) of for example 20.7 kg/mol and a constant Mₙ(A) of for example 5.5 kg/mol. The same applies to a plot of E against nₛ for all values from Table 3 having a constant Mₙ(B) of for example 22.2 kg/mol and a constant Mₙ(A) of for example 5.5 kg/mol. For analogous reasons as outlined above for Mₙ(A), an upper limit of nₛ of 15 is necessary in order to obtain a graft copolymer having good phase compatibilizer efficiency E and good mobility in the polymer melt.

Evaluations of the data in Tables 2 and 3 additionally show that, above a value of about 50 kg/mol for the product Mₙ(A)×nₛ, a further increase in the value of this variable no longer brings any significant further improvements in phase compatibilizer efficiency in the sense of a higher value E=(1−γ/γ₀). This is evident for example not just from a plot of E against Mₙ(A)×nₛ for all values from Table 2 having a constant Mₙ(B) of for example 20.7 kg/mol or for all values from Table 3 having a constant Mₙ(B) of for example 22.2 kg/mol, but also in the case of corresponding plots for other constant Mₙ(B) values within the range of the invention.

Finally, evaluations of the data in Tables 2 and 3 show that, above a value of about 50 kg/mol for Mₙ(B), a further increase in the value of this variable no longer brings any significant further improvements in phase compatibilizer efficiency in the sense of a higher value E=(1−γ/γ₀). This is evident for example from a plot of E against Mₙ(B) for all values from Table 2 having a constant Mₙ(A) of for example 6.3 kg/mol and a constant nₛ of for example 11.

Above the cited values for Mₙ(B), Mₙ(A), nₛ, and Mₙ(A)×nₛ, there is little or no improvement in the phase compatibilizer efficiency of the graft copolymer in the equilibrium state, on the contrary, further increases in these variables characterizing the graft copolymer are an obstacle to the desired aim; minimizing the molecular weight of the graft copolymer maximizes its mobility in the polymer melt mixture, which means it reaches equilibrium more swiftly.

The data in Table 4 show that graft copolymers having doubly terminally grafted and especially centrally grafted architecture exhibit improved phase compatibilizer efficiency in the sense of a higher value E=(1−γ/γ₀) compared to graft copolymers having uniformly equidistantly grafted and especially singly terminally grafted architecture comparable in their chemical composition, number of graft branches, and molar masses of graft backbone and graft branches.

For some selected simulation experiments from Table 2, the number of simulation steps necessary to reach the equilibrium state was evaluated. The results of this analysis are shown in Table 5.

TABLE 5
Selected experiments and number of simulation steps

| | | | | | Mₙ(A) × nₛ | | | |
|---|---|---|---|---|---|---|---|---|
| | | | | Mₙ(A) | (graft | Mₙ | | Number of |
| | | | Mₙ(B) | (graft | branches, | (graft | | simulation |
| | | | (backbone) | branch) | total) | copolymer) | | steps until |
| No. | Backbone | nₛ | [kg/mol] | [kg/mol] | [kg/mol] | [kg/mol] | E | equilibrium |
| 4 | Poly styrene | 11 | 42.1 | 6.3 | 69.7 | 111.8 | 53 | 1.6E+06 |
| 9 | Poly styrene | 11 | 42.1 | 3.2 | 34.8 | 76.9 | 47 | 1.3E+06 |
| 6 | Poly styrene | 3 | 42.1 | 6.3 | 19.0 | 61.1 | 50 | 1.1E+06 |

The data in Table 5 confirm that at higher values for Mₙ(A), Mₙ(B), and nₛ, and thus at higher molar masses Mₙ for the graft copolymer and at a higher value for the product Mₙ(A)×nₛ, more simulation steps are necessary to achieve steady-state equilibrium. Transferred to a real polymer mixture, this means that a longer time is needed until a stable distribution of the graft copolymer in the mixture and thus a stable morphology of the components, i.e. polymers A and B and the graft copolymer, has been achieved. This accordingly necessitates an increase in the set residence time in the mixing unit, such as an extruder, which is in many cases achievable only with difficulty by the equipment or is accompanied by other drawbacks such as thermal damage to the polymer components. A major influence on the number of simulation steps necessary to reach steady-state equilibrium is here, firstly, the number nₛ of graft branches (experiments 4 and 6) and, secondly, the value of Mₙ(A), i.e. the molecular weight of the graft branches (experiments 4 and 9), and thus, as a consequence, especially the value for the product Mₙ(A)×nₛ (all data in Table 5).

From the data in Table 5, it can thus be deduced that, with regard to minimizing the number of simulation steps necessary to reach equilibrium or, transposed to the industrial level, with regard to minimizing the residence times necessary to reach such a desired steady-state equilibrium, it is advisable not to select the values for nₛ and Mₙ(A), and in particular the value for the product Mₙ(A)×nₛ, any higher than is absolutely necessary for achieving the desired phase compatibilizer efficiency E. This consideration results in upper limits for the values of these three characteristics, above which the improvement in phase compatibilizer efficiency E shows only little or no longer significant improvement, but the residence times necessary to reach the state of equilibrium that must be established in order to achieve this phase compatibilizer efficiency E increase sharply.

Corresponding investigations into the number of simulation steps until equilibrium were also performed for the preferred graft copolymers having specific graft architecture (“doubly terminally grafted” and “centrally grafted”). These studies found no effect due to the architecture compared to “uniformly equidistantly grafted” graft copolymers having identical values for nₛ, Mₙ(A), and Mₙ(B), i.e. the number of simulation steps until equilibrium was, within the determination accuracy of this variable, the same for all three different graft copolymer architectures.

1. A graft copolymer of the general structure B-(A), consisting of blocks of two polymers A and B of differing chemical composition, wherein one of the polymers is a polycondensation polymer selected from the group consisting of polycarbonates, polyestercarbonates, polyesters, and polyamides and the other polymer is a polymer composed of at least one vinyl monomer,
characterized in that
(i) the number-average molecular weight of the block of polymer B Mₙ(B) is at least 13 kg/mol, determined by a combination of gel-permeation chromatography and NMR spectroscopy,
(ii) the number of side chains in the graft copolymer n₅, determined by NMR spectroscopy, is at least 3 and not more than 15,
(iii) the number-average molecular weight of the blocks of polymer A Mₙ(A) is at least 1.5 kg/mol and not more than 15 kg/mol, determined by a combination of gel-permeation chromatography and NMR spectroscopy, and
(iv) nₛ multiplied by Mₙ(A) comes to at least 13 kg/mol.

2. The graft copolymer as claimed in claim 1, wherein polymer A is selected from the group consisting of aromatic polycarbonates, aromatic polyestercarbonates, and aromatic polyesters.

3. The graft copolymer as claimed in claim 1, wherein polymer A is an aromatic polycarbonate.

4. The graft copolymer as claimed in claim 1, wherein polymer B is a polymer of one or more different vinyl monomers selected from the group consisting of styrene, styrene derivatives, acrylonitrile, acrylic esters, acrylic ester derivatives, olefins, maleimide, and maleimide derivatives.

5. The graft copolymer as claimed in claim 4, wherein the vinyl monomers are selected from the group consisting of styrene, acrylonitrile, methyl methacrylate, glycidyl methacrylate, and olefins.

6. The graft copolymer as claimed in claim 1, characterized in that the following features are present:
(i) Mₙ(B) is at least 23 kg/mol,
(ii) nₛ is at least 6,
(iii) Mₙ(A) is at least 4.5 kg/mol,
(iv) nₛ multiplied by Mₙ(A) comes to at least 13 kg/mol, and
(v) Mₙ(A)·n₅/[Mₙ(B)+Mₙ(A)·n₅] is in the range from 0.40 to 0.70.

7. The graft copolymer as claimed in claim 1, wherein nₛ is not more than 12.

8. The graft copolymer as claimed in claim 1, wherein Mₙ(B) is not more than 200 kg/mol.

9. The graft copolymer as claimed in claim 1, wherein Mₙ(A) is not more than 12 kg/mol.

10. The graft copolymer as claimed in claim 1, wherein nₛ multiplied by Mₙ(A) is not more than 80 kg/mol.

11. The graft copolymer as claimed in claim 1, wherein the architecture of the graft copolymer is selected from doubly terminally grafted and centrally grafted.

12. (canceled)

13. A polymer composition comprising polymers A and B and, as component C, a graft copolymer as claimed in claim 1,
wherein polymers A and B have the same chemical structure as the blocks of polymers A and B in the graft copolymer corresponding to component C.

14. The polymer composition as claimed in claim 13, wherein the ratio of the mass fraction of polymer A in the polymer composition, based on the sum total of polymers A and B in the composition, to the mass fraction of the graft branches in the graft copolymer corresponding to component C is 0.6 to 1.4.

15. A molded article comprising a composition as claimed in claim 13.
